(19) United States
(12) Patent Application Publication
(10) Pub. No.: US 2005/0265730 A1
(43) Pub. Date: Dec. 1, 2005

(54) Optical transmission system, and trasmitter, receiver and signal level adjustment method for use therein

(76) Inventors: Toshihiko Yasue, Moriguchi (JP); Masaru Fuse, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/524,675

(22) PCT Filed: Jun. 11, 2004
(86) PCT No.: PCT/JP04/08577

§ 371 Date: Feb. 14, 2005

(30) Foreign Application Priority Data
Jun. 13, 2003 (JP) 2003-169067

(51) Int. Cl. H04B 10/04

(52) U.S. Cl. 398/183

(57) ABSTRACT

In a transmitter (11), a peak detection section (104) detects a peak factor of a frequency division multiplexed signal which is output from a frequency division multiplex section (103). A spurious calculation section (105) instructs a gain adjustment section (106) to adjust the signal level of the frequency division multiplexed signal so that the level of spurious components (e.g., adjacent channel leakage power ratio (ACLR)) is equal to or less than a predetermined level, based on the peak factor.

### TECHNICAL FIELD

The present invention relates to an optical transmission system as well as a transmitter, a receiver, and a method for use therein. More particularly, the present invention relates to a subscriber line (DSL: Digital Subscriber Line)-compatible optical transmission system, an optical transmission system for CATV, or an optical transmission system for wireless signals, a so-called ROF (Radio-Over-Fiber) system, as well as a transmitter, a receiver, and a method for use therein.

### BACKGROUND ART

FIG. 19 is a block diagram showing the structure of a conventional optical transmission system. In FIG. 19, the conventional optical transmission system comprises a multiplex section 81, an optical modulation section 82, an optical transmission path 83, an optical detection section 84, a demultiplex section 85, first to n^{th} basic modulation sections 86-1 to 86-n, first to n^{th} electrical transmission paths 87-1 to 87-n, and first to n^{th} demodulation sections 88-1 to 88-n. Note that the first to n^{th} transmission paths 87-1 to 87-n may alternatively be wireless paths.

Hereinafter, an operation of the optical transmission system shown in FIG. 19 will be described. The multiplex section 81 multiplexes a plurality of input digital data signals. The optical modulation section 82 converts a signal which has been multiplexed by the multiplex section 81 into an optical signal, and sends it onto the optical transmission path 83. The optical detection section 84 converts the optical signal which has been transmitted over the optical transmission path 83 back into an electrical signal. The demultiplex section 85 separates the plurality of digital data signals which are multiplexed to the electrical signal obtained through the re-conversion by the optical detection section 84. The first to n^{th} basic modulation sections 86-1 to 86-n convert the digital data signals which have been separated by the demultiplex section 85 into modulated signals, which are output onto the first to n^{th} electrical transmission paths 87-1 to 87-n, respectively. The first to n^{th} demodulation sections 88-1 to 88-n respectively convert the modulated signals which have been transmitted over the first to n^{th} electrical transmission paths 87-1 to 87-n back into the plurality of original digital data signals.

The optical transmission system shown in FIG. 19 is generally applied to a digital subscriber line (DSL, especially VDSL: Very-high-speed Digital Subscriber Line) service. In a DSL service, optical sending equipment 801, which includes the multiplex section 81 and the optical modulation section 82, may be installed at a center office (CO) of a telephone company or the like. An optical terminal device 802, which includes the optical detection section 84, the demultiplex section 85, and the basic modulation sections 86-1 to 86-n, may be installed in a common utility portion of a multi-dwelling unit (MDU), a multi-tenant unit (MTU), on a side wall of a subscriber's residence, or on top of a utility pole, etc. First to n^{th} subscriber terminals 803-1 to 803-n, which respectively include the demodulation sections 88-1 to 88-n, may each be installed within a subscriber's residence. Subscriber lines are used as the respective electrical transmission paths 87-1 to 87-n.

In the above conventional optical transmission system, a large part of the entire transmission path from the optical sending equipment 801 to the subscriber terminals 803-1 to 803-n is constructed of optical fibers, which have a relatively low loss. Since digital signals are transmitted in the optical transmission system, the transmission characteristics are improved and the requirements for the performance of the transmission path are greatly relaxed.

On the other hand, the end portion (i.e., from the optical terminal device 802 to the subscriber terminals 803-1 to 803-n) of the entire transmission path, that is, the wiring within the subscriber's residence, is composed of electric wiring such as twisted-pair cables. Since DSL modulated signals are transmitted through this portion from the optical terminal device 802 to the subscriber terminals 803-1 to 803-n, the handling of the wiring within the subscriber's residence is facilitated, and the costs thereof can be reduced.

In accordance with this conventional technique, the entire transmission system can be elongated, while providing good installability and economy of the equipment within the subscriber's residence.

However, the above-described conventional transmission apparatus has a problem in that, due to the large size of the optical terminal device, there is a limit to the number of subscribers that can be accommodated, leading to high equipment costs, as described below. In the structure shown in FIG. 19, the optical terminal device 802 needs to include as many first to nt basic modulation sections 86-1 to 86-n as there are subscribers to be accommodated by the optical transmission system. As a result, the size of the optical terminal device 802 and the costs associated with the optical terminal device 802 are increased. Thus, the optical terminal device 802, which is installed on the subscriber side, increases in size and the costs associated therewith increase thereby unfavorably affecting the economy of the overall transmission system.

In order to solve the aforementioned problem, a technique of performing a conversion from a digital signal to modulated signals at the optical sending equipment has been proposed (e.g., Japanese Laid-Open Patent Publication No. 8-79178; Yasue et al., “Optical Access Technique for Multiple Channels of VDSL”, TECHNICAL REPORT OF IEICE, vol. 102, no. 358, OCS2002-64, pp. 17-22, Oct. 2002; and T. Yasue et. al., “Scalable Optical Access System for Multi-channel VDSL based on Subcarrier Multiplexing”, OSA Tech. Digest in Optical Fiber Communication Conference 2003, paper FM6, Atlanta, USA, March 2003.). Specifically, the optical sending equipment generates a plurality of modulated signals corresponding to the subscriber lines, subjects the modulated signals to a frequency division multiplex, converts the resultant signal to an optical signal, and sends out the optical signal onto the optical transmission path. In this case, the optical terminal device converts the optical signal which has been transmitted thereto to an electrical signal, subjects the electrical signal to a frequency separation, so as to be transmitted to the respective subscriber terminals. As a result, the basic modulation sections can be omitted from the optical terminal device, so that the problem of increased size and cost of the optical terminal device can be solved.

In this case, the modulated signals are transmitted over the optical transmission path. Therefore, it must be ensured that the entirety of the modulated signals satisfy a transmission capacity which can be tolerated by the optical transmission path. Therefore, when converting digital data signals into modulated signals, the optical sending equipment must set modulation parameters for the modulated signals so as to satisfy the transmission capacity which can be tolerated by the optical transmission path.

In recent years, modems have been proposed which, with a view to efficiently utilizing an optical transmission path, can dynamically change the modulation parameters for modulated signals in accordance with the state of use of each subscriber line and the transmission characteristics of the lines. Examples of such modems are VDSL modems. However, in the case where such a modem is used to convert digital data signals to modulated signals and the modulated signals are subjected to a frequency division multiplex before being transmitted from the optical sending equipment (transmitter) to the optical terminal device (receiver), a spurious component occurs on both sides of the spectrum of each modulated signal at the electrical-to-optical conversion section, due to the non-linearity of an optical transmission system, in particular a semiconductor laser diode which is used as an electrical-to-optical conversion element. Conventionally, no means has been provided for approximating and reducing such a spurious component. In particular, spurious was difficult to approximate and reduce in the case where the modulation method changes over time.

### DISCLOSURE OF THE INVENTION

Therefore, an object of the present invention is to provide: an optical transmission system, more specifically, a sub-carrier multiplexing (SCM) optical transmission system where modulated signals are subjected to a frequency division multiplex before optical transmission (e.g. a DSL-compatible optical transmission system), such that a spurious component occurring in the neighborhood of the spectrum of each modulated signal can be reduced; a transmitter; a receiver; and a method for use therein.

To achieve the above objects, the present invention has the following aspects. A first aspect of the present invention is directed to an optical transmission system having: a transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex; a receiver for converting the optical signal having been transmitted over the optical transmission path back into the frequency division multiplexed signal, and separating the frequency division multiplexed signal into the first to n^{th} modulated signals; and first to n^{th} terminal devices which are connected to the receiver via the first to n^{th} connection lines, respectively, for receiving the separated modulated signals, the system comprising: a peak detection section for detecting peak information concerning a peak of a signal level of the frequency division multiplexed signal; a spurious calculation section for, based on the peak information detected by the peak detection section, calculating desired-to-undesired-signal information of the frequency division multiplexed signal, and determining signal level information concerning a signal level for the frequency division multiplexed signal which ensures that the desired-to-undesired-signal information is equal to or greater than a predetermined level; and a gain adjustment section provided in the transmitter for, based on the signal level information determined by the spurious calculation section, adjusting the signal level of the frequency division multiplexed signal when being converted to the optical signal.

According to the first aspect, desired-to-undesired-signal information is determined based on peak information concerning a frequency division multiplexed signal. Based on the desired-to-undesired-signal information, signal level information concerning a signal level for the frequency division multiplexed signal which ensures that the desired-to-undesired-signal information is equal to or greater than a predetermined level. Based on the signal level information, the signal level of the frequency division multiplexed signal when being converted to the optical signal is adjusted. Thus, there is provided an optical transmission system, more specifically, a sub-carrier multiplexing (SCM) optical transmission system where modulated signals are subjected to a frequency division multiplex before optical transmission, in which the level of the frequency division multiplexed signal is adjusted so that a spurious component occurring in the neighborhood of the spectrum of each modulated signal is reduced. As a result, it becomes possible to utilize the optical transmission path in an efficient manner.

Preferably, the transmitter includes: first to n^{th} modulation sections for generating the first to n^{th} modulated signals based on first to n^{th} data signals to be transmitted to the first to n^{th} terminal devices; a frequency division multiplex section for outputting the frequency division multiplexed signal by subjecting the first to n^{th} modulated signals which are output from the first to n^{th} modulation sections to a frequency division multiplex; and an electrical-to-optical conversion section for converting into the optical signal the frequency division multiplexed signal which is output from the frequency division multiplex section, the signal level of the frequency division multiplexed signal having been adjusted by the gain adjustment section, and for sending the optical signal onto the optical transmission path, and the receiver includes: an optical-to-electrical conversion section for receiving the optical signal having been transmitted via the optical transmission path, and converting the optical signal back into the frequency division multiplexed signal; and a frequency demultiplex section for extracting the first to nt modulated signals from the frequency division multiplexed signal which is output from the optical-to-electrical conversion section, and sending the first to n^{th} modulated signals onto the first to n^{th} connection lines, respectively, and the first to n^{th} terminal devices each include a demodulation section for demodulating the modulated signal which is transmitted over a corresponding one of the first to n^{th} connection lines.

Preferably, the desired-to-undesired-signal information is spurious information concerning a spurious component of the frequency division multiplexed signal occurring in the electrical-to-optical conversion section or the like and the frequency division multiplexed signal itself, and the spurious calculation section determines, as the signal level information, information concerning a signal level for the frequency division multiplexed signal which ensures that a level of the spurious component represented by the spurious information is equal to or less than a predetermined level.

Thus, the signal level of the frequency division multiplexed signal can be adjusted so as to reduce the spurious component occurring in the neighborhood of each modulated signal.

For example, the peak information may be expressed by a peak factor ξ, which represents a ratio of a peak power to an average power, so called PAPR (Peak-to-Average Power Ratio), of the frequency division multiplexed signal, the spurious information may be expressed by an adjacent channel leakage power ratio (ACLR), which is determined in terms of: a spurious factor κ which is determined based on: a spurious amount, in accordance with the peak factor ξ, of a modulated signal corresponding to one channel; a level of second-order distortion (IM2) which is in accordance with a given optical modulation index (OMI) m in the electrical-to-optical conversion section; and a level of third-order distortion (IM3) which is in accordance with the given optical modulation index m in the electrical-to-optical conversion section; a level of composite second-order distortion (CSO) of the frequency division multiplexed signal which is in accordance with the given optical modulation index m in the electrical-to-optical conversion section; and a level of composite third-order distortion (CTB) of the frequency division multiplexed signal which is in accordance with the given optical modulation index m in the electrical-to-optical conversion section, and the spurious calculation section may determine, as the signal level information, an optical modulation index m which ensures that the adjacent channel leakage power ratio (ACLR) is equal to or less than a predetermined level. As used herein, the spurious factor κ is a parameter representing a difference between a spurious amount of a modulated signal and an amount of distortion based on sinusoidal waves.

For example, the optical transmission system may further comprise a ξ-m-κ table storage section for previously storing a ξ-m-κ table indicating correspondence between the peak factor ξ, the optical modulation index (OMI) m in the electrical-to-optical conversion section, and the spurious factor κ, wherein the spurious calculation section is operable to: determine a spurious factor κ which corresponds to the peak factor ξ detected by the peak detection section, by referring to the ξ-m-κ table stored in the ξ-m-κ table storage section; and search for an optical modulation index m which ensures that the adjacent channel leakage power ratio, which is expressed by the spurious factor κ, the level of composite second-order distortion, and the level of composite third-order distortion, is equal to or less than a predetermined level, and determines the optical modulation index m thus found as the signal level information.

Thus, the signal level of the frequency division multiplexed signal can be easily adjusted so as to reduce the spurious component occurring in the neighborhood of each modulated signal.

Preferably, the desired-to-undesired-signal information is a comprehensive signal quality ratio which is defined based on: spurious information concerning a spurious component of the frequency division multiplexed signal occurring in the electrical-to-optical conversion section; and carrier-to-noise information, and the spurious calculation section determines, as the signal level information, information concerning a signal level for the frequency division multiplexed signal which ensures that the comprehensive signal quality ratio becomes maximum.

Thus, the signal level of the frequency division multiplexed signal can be adjusted so as to reduce the spurious component occurring in the neighborhood of the modulated signal.

For example, the peak information may be expressed by a peak factor ξ, which represents a ratio of a peak power to an average power of the frequency division multiplexed signal, the spurious information may be expressed by an adjacent channel leakage power ratio, which is determined in terms of: a spurious factor κ which is determined based on: a spurious amount, in accordance with the peak factor ξ, of a modulated signal corresponding to one channel; a level of second-order distortion which is in accordance with a given optical modulation index m in the electrical-to-optical conversion section; and a level of third-order distortion which is in accordance with the given optical modulation index m in the electrical-to-optical conversion section; a level of composite second-order distortion of the frequency division multiplexed signal which is in accordance with the given optical modulation index m in the electrical-to-optical conversion section; and a level of composite third-order distortion of the frequency division multiplexed signal which is in accordance with the given optical modulation index m in the electrical-to-optical conversion section, the carrier-to-noise information may be expressed as a function of the optical modulation index m in the electrical-to-optical conversion section, the optical transmission system may further comprise: a ξ-m-κ table storage section for previously storing a ξ-m-κ table indicating correspondence between the peak factor ξ, the optical modulation index m in the electrical-to-optical conversion section, and the spurious factor κ; and a carrier-to-noise information storage section for previously storing correspondence between the optical modulation index m in the electrical-to-optical conversion section and the carrier-to-noise information, the spurious calculation section may be operable to: determine a spurious factor κ which corresponds to the peak factor ξ detected by the peak detection section, by referring to the ξ-m-κ table stored in the ξ-m-κ table storage section; determine the adjacent channel leakage power ratio which is expressed by the spurious factor κ, the level of composite second-order distortion, and the level of composite third-order distortion; and determine, as the signal level information, an optical modulation index m in the electrical-to-optical conversion section which ensures that the comprehensive signal quality ratio, which is expressed by the adjacent channel leakage power ratio and the carrier-to-noise information, becomes maximum.

Thus, the signal level of the frequency division multiplexed signal can be easily adjusted so as to reduce the spurious component occurring in the neighborhood of the modulated-signal.

Preferably, the peak detection section detects the peak information by detecting the signal level of the frequency division multiplexed signal which is output from the frequency division multiplex section.

Thus, it becomes possible to detect peak information at the transmitter.

Preferably, the peak detection section detects the peak information-based on information concerning peaks of the first to n^{th} modulated signals which are output from the first to n^{th} modulation sections.

Thus, it becomes possible to detect peak information based on each modulated signal, whereby accuracy of the peak information is improved.

Preferably, the peak detection section detects the peak information by detecting the signal level of the frequency division multiplexed signal which is output from the optical-to-electrical conversion section.

Thus, it becomes possible to detect peak information at the receiver.

Preferably, the peak detection section detects the peak information by detecting the signal levels of the first to n^{th} modulated signals which are output from the frequency demultiplex section.

Thus, it becomes possible to detect peak information based on each modulated signal, whereby accuracy of the peak information is improved.

In one embodiment, the frequency division multiplex section includes a frequency conversion section for converting the first to n^{th} modulated signals to signals having respectively different frequencies, and the frequency demultiplex section includes an inverse frequency conversion section for converting the first to n^{th} modulated signals contained in the frequency division multiplexed signal to signals having their respective original frequencies.

Thus, even in the case where the frequency bands of the modulated signals overlap with one another, the modulated signals can still be subjected to a frequency division multiplex.

Preferably, the spurious calculation section determines the desired-to-undesired-signal information in accordance with a number n of channels of modulated signals.

Thus, there is provided an optical transmission system which, even in the case where the number of channels changes over time, enables adjustment of the level of the frequency division multiplexed signal so as to reduce spurious components which occur in the neighborhood of the spectrum of each modulated signal and which change over time.

Preferably, the receiver further includes: a distortion monitoring section for detecting a distortion level, at a predetermined frequency, of the frequency division multiplexed signal which is output from the electrical-to-optical conversion section; and a distortion information transmission section for transmitting distortion level information to the transmitter, the distortion level information representing the distortion level which is detected by the distortion monitoring section, and based on the distortion level information which is transmitted from the distortion information transmission section, the gain adjustment section adjusts the signal level of the frequency division multiplexed signal which is input to the electrical-to-optical conversion section so that the distortion level which is detected by the distortion monitoring section is equal to or less than a predetermined level.

Thus, the signal level of the frequency division multiplexed signal can be adjusted while taking into consideration the influence of distortions at the receiver, whereby distortions can be better suppressed. Moreover, within a frequency band in which a plurality of modulated signals are deployed, only a specific frequency band which is most susceptible to distortions is selectively monitored. As a result, it becomes possible to detect the influence of distortions without having to measure a distortion level a with respect to every frequency band.

Preferably, each terminal device further includes a quality detection section for detecting a signal quality of an output signal from the demodulated by the demodulation section, and transmitting the signal quality as signal quality information to the transmitter via the receiver, and the gain adjustment section adjusts the signal level of the frequency division multiplexed signal which is input to the electrical-to-optical conversion section so that the signal quality which is represented by the incoming signal quality information satisfies a predetermined quality level.

Thus, based on the signal quality of each modulated signal, the signal level of the frequency division multiplexed signal is adjusted. As a result, the signal quality of the modulated signal can be maintained at a predetermined quality level.

A second aspect of the present invention is directed to a transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex, the transmitter comprising: a peak detection section for detecting peak information concerning a peak of a signal level of the frequency division multiplexed signal; a spurious calculation section for, based on the peak information detected by the peak detection section, calculating desired-to-undesired-signal information of the frequency division multiplexed signal, and determining signal level information concerning a signal level for the frequency division multiplexed signal which ensures that the desired-to-undesired-signal information is equal to or greater than a predetermined level; and a gain adjustment section for, based on the signal level information determined by the spurious calculation section, adjusting the signal level of the frequency division multiplexed signal when being converted to the optical signal.

A third aspect of the present invention is directed to a receiver for use in conjunction with a transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex, the receiver converting the optical signal having been transmitted from the transmitter back into the frequency division multiplexed signal and separating the frequency division multiplexed signal into the first to n^{th} modulated signals, the receiver comprising: a peak detection section for detecting peak information concerning a peak of a signal level of the frequency division multiplexed signal, wherein, the peak information detected by the peak detection section is used for calculating desired-to-undesired-signal information of the frequency division multiplexed signal, the desired-to-undesired-signal information being used for determining signal level information concerning a signal level for the frequency division multiplexed signal which ensures that the desired-to-undesired-signal information is equal to or greater than a predetermined level; and the signal level information is used for adjusting the signal level of the frequency division multiplexed signal when being converted to the optical signal.

A fourth aspect of the present invention is directed to a signal level adjustment method for adjusting a signal level of a frequency division multiplexed signal for use in an optical transmission system having: a transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex; a receiver for converting the optical signal having been transmitted over the optical transmission path back into the frequency division multiplexed signal, and separating the frequency division multiplexed signal into the first to n^{th} modulated signals; and first to n^{th} terminal devices which are connected to the receiver via the first to n^{th} connection lines, respectively, for receiving the separated modulated signals, the method comprising the steps of: detecting peak information concerning a peak of a signal level of the frequency division multiplexed signal; calculating desired-to-undesired-signal information of the frequency division multiplexed signal based on the detected peak information; determining signal level information concerning a signal level for the frequency division multiplexed signal which ensures that the desired-to-undesired-signal information is equal to or greater than a predetermined level; and based on the signal level information, adjusting the signal level of the frequency division multiplexed signal when being converted to the optical signal.

### BRIEF DESCRIPTION OF THE DRAWINGS

FIG. 1 is a block diagram illustrating the structure of an optical transmission system according to a first embodiment of the present invention.

FIG. 2A is a graph illustrating the spectra of a frequency division multiplexed signal which is output from a frequency division multiplex section 103 in the case where the modulated signals are QAM (Quadrature Amplitude Modulation) signals.

FIG. 2B is a graph illustrating the spectra of a frequency division multiplexed signal in the case where the modulated signals are DMT (Discrete Multi-Tone) signals.

FIG. 3 is a graph illustrating changes over time of the amplitude level of a frequency division multiplexed signal for explaining a detection method and the definition of a peak factor ξ.

FIG. 4A is a graph illustrating a spectrum of a single modulated signal contained in a frequency division multiplexed signal which is output from an optical-to-electrical conversion section 109 and a spectrum of a spurious component (undesired signal component) associated therewith, under a peak factor ξ=ξ₁.

FIG. 4B is a graph illustrating a spectrum of a single modulated signal contained in a frequency division multiplexed signal which is output from an optical-to-electrical conversion section 109 and a spectrum of a spurious component (undesired signal component) associated therewith, under a peak factor ξ=ξ₂.

FIG. 5 is a graph illustrating a relationship between a peak factor of a frequency division multiplexed signal and a spurious amount thereof.

FIG. 6A is a graph illustrating a spectrum of a modulated signal corresponding to one channel and a spectrum of a spurious component associated therewith (where there is a spurious amount of ACLR_{1ch}).

FIG. 6B is a graph illustrating the spectra of two channels of sinusoidal waves (two tones), spectra of second-order distortions associated therewith (IM2), and spectra of third-order distortions associated therewith (IM3).

FIG. 6C is a graph illustrating the spectra of modulated signals corresponding to n channels and spectra of spurious components associated therewith (where there is a spurious amount of ACLR_{Nch} each).

FIG. 6D is a graph illustrating the spectra of n channels of sinusoidal waves (C), as well as spectra of second-order distortions (CSO: Composite second-Order distortion) and third-order distortions (CTB: Composite Triple Beat) associated therewith.

FIG. 7 is a schematic diagram illustrating a ξ-m-κ table.

FIG. 8 is a schematic diagram illustrating an m-additional term table.

FIG. 9 is a schematic diagram illustrating an m-1/CNR table.

FIG. 10 is a flowchart illustrating an operation of a spurious calculation section 105.

FIG. 11 is a flowchart illustrating an operation of a spurious calculation section in the case of obtaining, from a previously-stored tables, a value of an optical modulation index m which ensures that the value of a spurious amount ACLR_{Nch}(ξ, m) is equal to or less than a predetermined level.

FIG. 12 is a graph illustrating, with respect to each modulated signal in a frequency division multiplexed signal which is output from an optical-to-electrical conversion section 109, dependencies on the optical modulation index of a carrier-to-noise ratio (CNR), ACLR₁ and ACLR₂ illustrated in FIG. 5, and IM3 and CTB illustrated in FIG. 6B and FIG. 6D.

FIG. 13 is a block diagram illustrating the structure of an optical transmission system according to a second embodiment of the present invention.

FIG. 14A is a graph illustrating exemplary frequency characteristics of second-order distortion (CSO) which is detected by a distortion monitoring section 113.

FIG. 14B is a graph illustrating exemplary frequency characteristics of third-order distortion (CTB) which is detected by a distortion monitoring section 113.

FIG. 15 is a block diagram illustrating the structure of an optical transmission system according to a third embodiment of the present invention.

FIG. 16 is a block diagram illustrating the structure of an optical transmission system in the case where peak information is obtained by detecting peak values of first to n^{th} modulated signals which are output from first to n^{th} modulation sections 102-1 to 102-n.

FIG. 17 is a block diagram illustrating the structure of an optical transmission system in the case where peak information is obtained by detecting peak values of a frequency division multiplexed signal which is output from an optical-to-electrical conversion section 109.

FIG. 18 is a block diagram illustrating the structure of an optical transmission system in the case where peak information is obtained by detecting peak values of first to n^{th} modulated signals which are output from a frequency demultiplex section 110.

FIG. 19 is a block diagram illustrating the structure of a conventional optical transmission system.

### BEST MODE FOR CARRYING OUT THE INVENTION

### First Embodiment

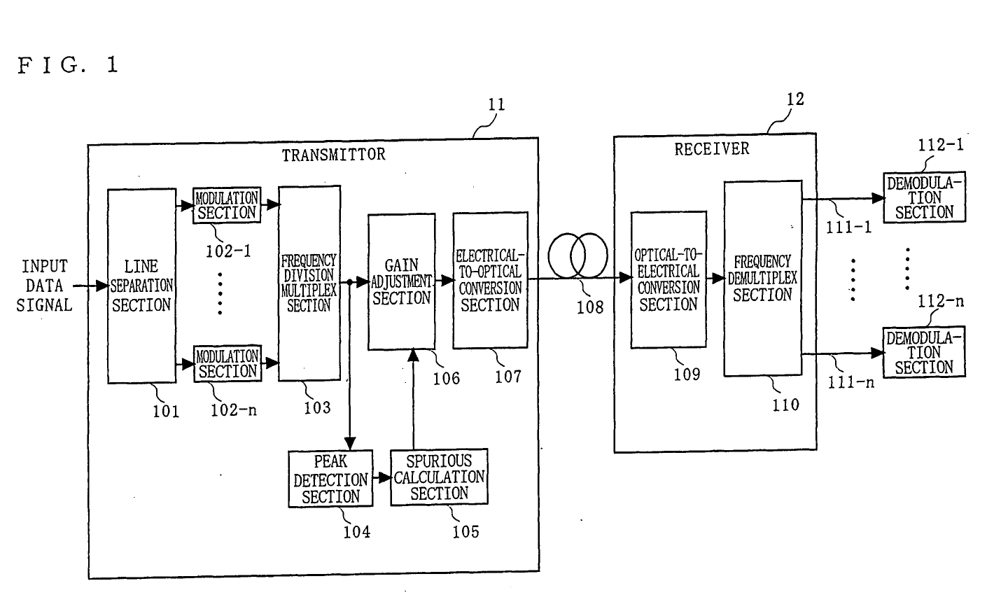

FIG. 1 is a block diagram illustrating the structure of an optical transmission system according to a first embodiment of the present invention. In FIG. 1, the optical transmission system comprises a transmitter 11, a first optical transmission path 108, a receiver 12, first to n^{th} subscriber lines 111-1 to 111-n, and first to n^{th} demodulation sections (terminal devices) 112-1 to 112-n. Herein, it is assumed that n is an integer which is equal to or greater than two.

The transmitter 11 is connected to the receiver 12 via the first optical transmission path 108. The transmitter 11 may be installed in a center office (CO) of a telephone company or the like, for example.

The receiver 12 may be installed in a common utility portion of a multi-dwelling unit (MDU), for example. The receiver 12 is connected to the first to n^{th} demodulation sections 112-1 to 112-n, via the subscriber lines (first to n^{th} subscriber lines 111-1 to 111-n), respectively.

The subscriber lines 111-1 to 111-n may be, for example, telephone lines (i.e., twisted pair cables), coaxial cables, or wireless lines.

The first to n^{th} demodulation sections 112-1 to 112-n respectively correspond to subscribers' modems, and are installed at the respective subscribers' residences.

The optical transmission system according to the present embodiment has a constitution which utilizes a VDSL technique in the form of so-called FTTB (Fiber-To-The-Building) or so-called FTTC (Fiber-To-The-Curb).

The transmitter 11 comprises a line separation section 101, first to n^{th} modulation sections 102-1 to 102-n, a frequency division multiplex section 103, a gain adjustment section 106, an electrical-to-optical conversion section 107, a peak detection section 104, and a spurious calculation section 105. It is to be understood that a k^{th} modulation section 102-k (where k is an integer which may take any value from 2 to n) has a similar function to that of the first modulation section 102-1.

The receiver 12 includes an optical-to-electrical conversion section 109 and a frequency demultiplex section 110.

The line separation section 101 separates an input data signal into first to n^{th} data signals for output. Herein, the first to n^{th} data signals are signals to be transmitted to the first to n^{th} demodulation sections 112-1 to 112-n over the first to n^{th} subscriber lines 111-1 to 111-n, respectively.

First to n^{th} data signals are respectively input to the first to n^{th} modulation sections 102-1 to 102-n. Hereinafter, an operation of the first to n^{th} modulation sections 102-1 to 102-n will be described, taking the first modulation section 102-1 for example. The first modulation section 102-1, which is provided corresponding to a first data signal that is output from the line separation section 101, converts the first data signal to a first modulated signal based on a predetermined modulation parameter(s). Herein, a signal which is output from any k^{th} modulation section 102-k will be referred to as a “k^{th} modulated signal”.

The operation of the first modulation section 102-1 will be more specifically described. In accordance with the predetermined modulation parameter(s), the first modulation section 102-1 modulates the first data signal which has been output from the line separation section 101 into a modulated signal, and outputs the modulated signal. In the present embodiment, the first modulation section 102-1 performs QAM (Quadrature Amplitude Modulation) in accordance with the predetermined modulation parameter(s). As used herein, the modulation parameter(s) may include an M-ary constellation size, power spectral density (PSD), modulation band width, and/or the like. The modulation parameter(s) is to be determined based on the state of communication and the transmission path state on the first connection line, and are variable. The modulation parameter(s) is changed in accordance with an instruction from a control section (not shown). Any k^{th} modulation section 102-k also performs a similar operation.

The frequency division multiplex section 103 subjects the first to n^{th} modulated signals which have been output from the first to n^{th} modulation sections 102-1 to 102-n, respectively, to a frequency division multiplex. Herein, a signal which is obtained by subjecting modulated signals to a frequency division multiplex will be referred to as a “frequency division multiplexed signal”. The frequency division multiplex section 103 may be of either a construction which does not involve frequency conversion, or a construction which involves frequency conversion. The frequency division multiplex section 103 has a construction which does not involve a frequency conversion in the case where the first to n^{th} modulated signals which are input to the frequency division multiplex section 103 already have respectively different frequency bands. On the other hand, the frequency division multiplex section 103 has a construction which involves a frequency conversion in the case where some of the first to n^{th} modulated signals may have the same frequency band. In the latter case, before performing a frequency division multiplex, the frequency division multiplex section 103 subjects the input modulated signals to a frequency conversion to ensure that the first to n^{th} modulated signals have respectively different frequency bands. In other words, the frequency division multiplex section may comprise a frequency conversion section capable of performing frequency conversion for the first to n^{th} modulated signals so as to have respectively different frequency bands, and subject resultant modulated signals which are output from the frequency conversion section to a frequency division multiplex.

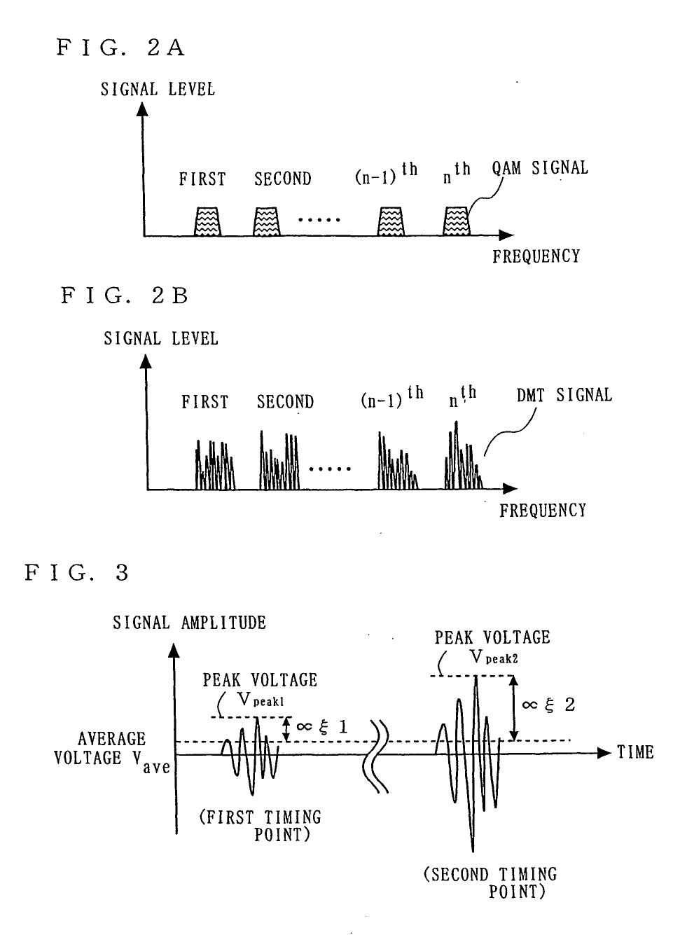

FIG. 2A is a graph illustrating the spectra of a frequency division multiplexed signal which is output from a frequency division multiplex section 103 in the case where the modulated signals are QAM signals. As shown in FIG. 2A, the frequency division multiplexed signal is a signal which is obtained by subjecting the first to n^{th} modulated signals (which are QAM signals) to a frequency division multiplex. The QAM signals are respectively modulated by using independent modulation parameters. It is assumed that each modulation parameter is changed over time by a control section, depending on the state of use of each subscriber line and the transmission characteristics of the lines, and the like. Although it is assumed herein that the modulated signals are QAM signals, they may alternatively be DMT (Discrete Multi tone modulation) signals. FIG. 2B is a graph illustrating the spectra of a frequency division multiplexed signal in the case where the modulated signals are DMT signals.

The peak detection section 104 is composed of a peak hold circuit or the like. With a predetermined time cycle, the peak detection section 104 detects a peak factor ξ, as information concerning peaks of the signal (amplitude) level of the frequency division multiplexed signal which is output from the frequency division multiplex section 103 (hereinafter “peak information”) FIG. 3 is a graph illustrating changes over time of the amplitude level of a frequency division multiplexed signal for explaining a detection method and the definition of a peak factor ξ.

Since the modulation parameters of the first to n^{th} modulated signals change over time, the amplitude level of the frequency division multiplexed signal also changes over time, as shown in FIG. 3. With a predetermined time cycle, the peak detection section 104 detects an average voltage and a peak voltage of the frequency division multiplexed signal. In FIG. 3, the peak detection section 104 is shown as detecting an average voltage Vₐᵥₑ and a peak voltage Vₚₑₐₖ₁ of the frequency division multiplexed signal at a first timing point (shown by the left waveform in FIG. 3), and detecting an average power Vₐᵥₑ and a peak voltage Vₚₑₐₖ₂ of the frequency division multiplexed signal at a second timing point (shown by the right waveform in FIG. 3). It is assumed herein that the average voltage Vₐᵥₑ is the same at both first and second timing points, and that the n modulated signals all have the same average power. As a peak factor ξ, the peak detection section 104 detects a ratio of a peak power Pₚₑₐₖ based on the detected peak voltage Vₚₑₐₖ to an average signal power Pₐᵥₑ based on the detected average voltage Vₐᵥₑ, i.e., ξ=Pₚₑₐₖ/Pₐᵥₑ. Hereinafter, the peak factor when detecting the peak voltage Vₚₑₐₖ₁ will be referred to as “ξ₁”, and the peak factor when detecting the peak voltage Vₚₑₐₖ₂ as “ξ₂”.

Based on the peak factor ξ of the frequency division multiplexed signal which has been detected by the peak detection section 104, the spurious calculation section 105 calculates a spurious amount (ACLR: Adjacent Channel Leakage power Ratio) ACLR_{Nch} (ξ,m) of the N(=n) channel frequency division multiplexed signal. Based on the spurious amount ACLR_{Nch} (ξ,m) of the N-channel frequency division multiplexed signal, the spurious calculation section 105 calculates a comprehensive signal quality ratio (DUR: Desired-to-Undesired Ratio) DUR(ξ,m), which represents a ratio of the desired signal power to the undesired signal power. Furthermore, as signal level information concerning the signal level of the frequency division multiplexed signal, the spurious calculation section 105 calculates an optical modulation index m for the electrical-to-optical conversion section 107 which ensures that DUR(ξ, m) becomes maximum (i.e., the undesired signal becomes minimum).

Since the spurious amount ACLR_{Nch} (ξ,m) and the comprehensive signal quality ratio DUR(ξ, m) are values which vary depending on the peak factor ξ and the optical modulation index m, each of these values is expressed as a function of the peak factor ξ and the optical modulation index m. The comprehensive signal quality ratio is information which represents a ratio of the desired signal power to the undesired signal power, and therefore may also be referred to as “desired-to-undesired-signal information”. The spurious amount is information which represents a relationship between a spurious component of the frequency division multiplexed signal and the frequency division multiplexed signal itself, and therefore may also be referred to as “spurious information”. It is assumed that the comprehensive signal quality ratio has a positive value which increases as the power of the undesired signal decreases. It is assumed that the spurious amount (adjacent channel leakage power ratio) has a negative value which is obtained by subtracting the level of a modulated signal from the level of the spurious component associated with the modulated signal, such that the spurious amount decreases as the level of the spurious component decreases. Thus, the greater the comprehensive signal quality ratio is, the smaller the spurious amount is, i.e., the quality is better.

The spurious calculation section 105 passes the calculated optical modulation index m (as signal level information) to the gain adjustment section 106.

The spurious calculation section 105 may be realized by, for example, an integrated circuit or the like which is programmed to perform a predetermined procedure. The operation of the spurious calculation section 105 will be described later in detail. The optical modulation index m is represented as a ratio of a modulated current value which is input to the electrical-to-optical conversion section 107 (i.e., a current value (Im) of the frequency division multiplexed signal) to a value which is obtained by subtracting a threshold current (Ith) from a bias current (Ib) of the electrical-to-optical conversion section 107. In other words, m=I/?Ib=Im/(Ib−Ith). The optical modulation index m is a parameter representing an average power corresponding to one channel of the frequency division multiplexed signal which is input to the electrical-to-optical conversion section 107.

Based on the optical modulation index m which is provided from the spurious calculation section 105, the gain adjustment section 106 determines a signal level of the frequency division multiplexed signal to be input to the electrical-to-optical conversion section 107, and outputs the frequency division multiplexed signal with its signal level being adjusted as determined.

The electrical-to-optical conversion section 107 converts the frequency division multiplexed signal which is output from the gain adjustment section 106 to an optical signal, and outputs the optical signal. The electrical-to-optical conversion section 107 may be implemented by, for example, a direct modulation method which employs a semiconductor laser diode as a light source, and modulates an injected current with the frequency division multiplexed signal so as to output an optical signal.

The first optical transmission path 108 propagates the optical signal which has been output from the electrical-to-optical conversion section 107 to the receiver 12.

The optical-to-electrical conversion section 109 converts the optical signal which has been transmitted over the first optical transmission path 108 back into a frequency division multiplexed signal.

The frequency demultiplex section 110 separates the frequency division multiplexed signal which has been output from the optical-to-electrical conversion section 109 into first to n^{th} modulated signals for output. The frequency demultiplex section 110 is supposed to perform an entirely opposite operation to that performed by the frequency division multiplex section 103. In the case where the frequency division multiplex section 103 has performed a frequency conversion, the frequency-converted first to n^{th} modulated signals are to be converted back to their original frequencies. In this case, the frequency demultiplex section includes an inverse frequency conversion section for converting the first to n^{th} modulated signals contained in the frequency division multiplexed signal back to their original frequencies for output.

The first to n^{th} subscriber lines 111-1 to 111-n are provided corresponding to the first to n^{th} modulated signals, respectively. The first to n^{th} subscriber lines 111-1 to 111-n propagate the first to n^{th} modulated signals, respectively, which have been separated by the frequency demultiplex section 110.

The first to n^{th} demodulation sections 112-1 to 112-n are connected to the first to n^{th} subscriber lines 111-1 to 111-n, respectively. The first to n^{th} demodulation sections 112-1 to 112-n demodulate the first to n^{th} modulated signals which have been transmitted over the subscriber lines 111-1 to 111-n, respectively. In the present embodiment, each of the first to n^{th} demodulation sections 112-1 to 112-n may be a VDSL modem or the like which can demodulate a modulated signal based on a plurality of modulation parameters. Finally, the first to n^{th} demodulation sections 112-1 to 112-n reproduce the demodulated first to n^{th} data signals, respectively.

Thus, the first to n^{th} data signals are transmitted from the transmitter 11 (center office) to the first to n^{th} demodulation sections 112-1 to 112-n (i.e., the respective subscriber residences).

Next, prior to describing the detailed operation of the spurious calculation section 105, a relationship between the peak factor ξ of the frequency division multiplexed signal, the spurious amount ACLR_{Nch} (m) of the N-channel frequency division multiplexed signal, and the comprehensive signal quality ratio DUR (m) will be described.

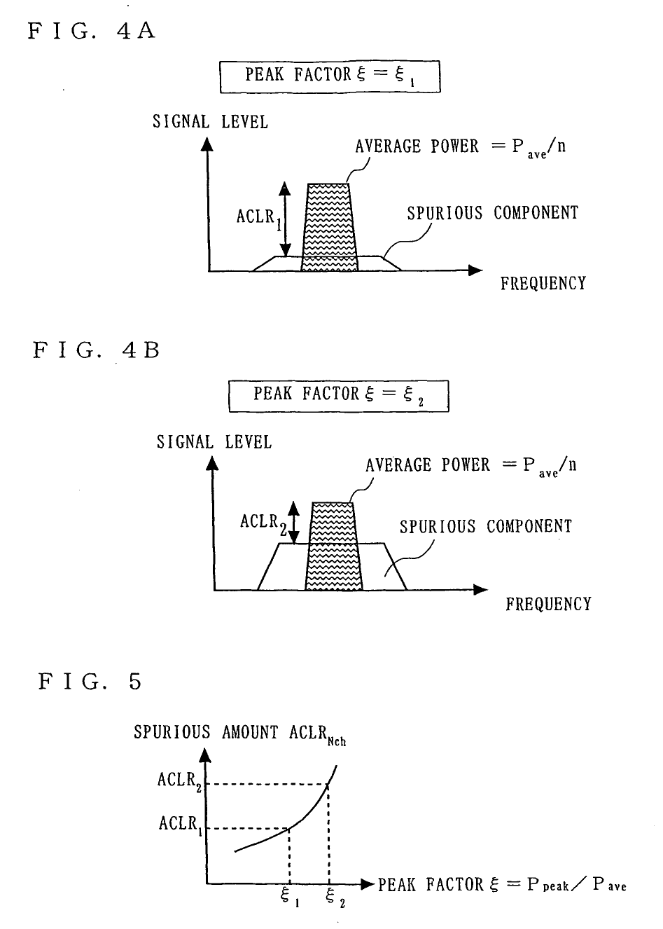

FIG. 4A is a graph illustrating a spectrum of a single modulated signal contained in a frequency division multiplexed signal which is output from the optical-to-electrical conversion section 109 and a spectrum of a spurious component (undesired signal component) associated therewith, under a peak factor ξ=ξ₁. It is assumed that the spurious component shown in FIG. 4A has a spurious amount of ACLR₁.

FIG. 4B is a graph illustrating a spectrum of a single modulated signal contained in a frequency division multiplexed signal which is output from the optical-to-electrical conversion section 109 and a spectrum of a spurious component (undesired signal component) associated therewith, under a peak factor ξ=ξ₂. It is assumed that the spurious component shown in FIG. 4B has a spurious amount of ACLR₂. The adjacent channel leakage power ratio, by which the spurious amount is represented, is a suitable parameter for evaluating spurious components.

Herein, it is assumed that the average power Pₐᵥₑ/n of the modulated signal is the same both for the case of ξ=ξ₁ and for the case of ξ₂. Thus, it will be seen from FIG. 4A and FIG. 4B that, even with the same average power Pₚₑₐₖ/n, the size of the spurious component may differ depending on the peak factor.

FIG. 5 is a graph illustrating a relationship between a peak factor of the frequency division multiplexed signal and a spurious amount thereof. As shown in FIG. 5, the spurious amount increases as the peak factor increases. This relationship is determined by the number N of channels, and the characteristics of the devices used in the electrical-to-optical conversion section 107, the first optical transmission path 108, the optical-to-electrical conversion section 109, and the like. Since the number N of channels and the characteristics of the devices used in the electrical-to-optical conversion section 107, the first optical transmission path 108, the optical-to-electrical conversion section 109, and the like are known in advance, the spurious amount can be uniquely determined once the peak factor is determined.

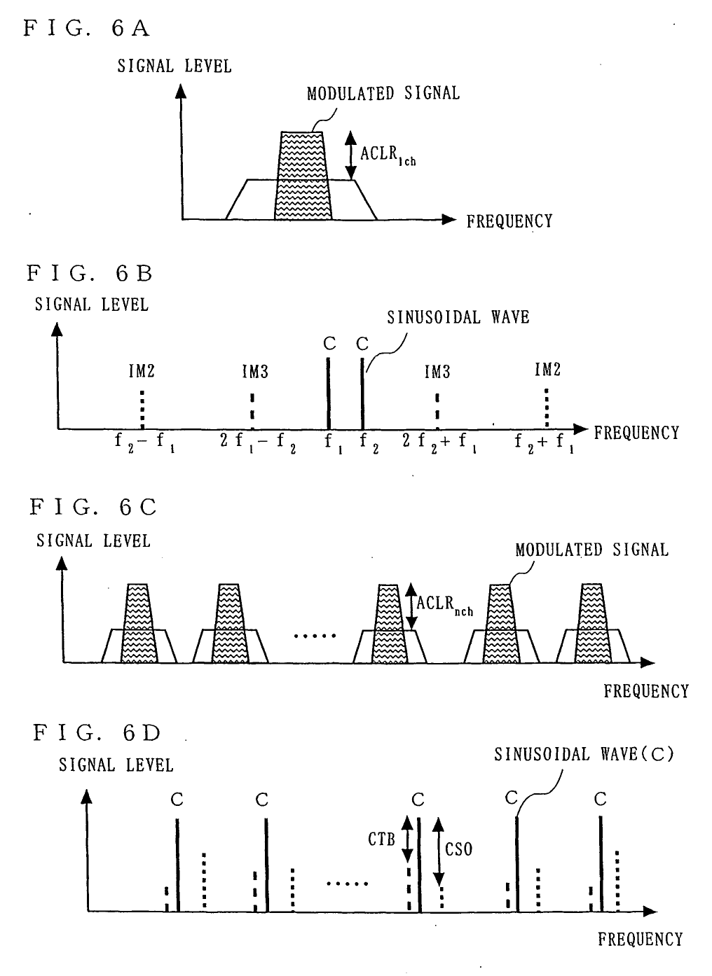

Next, the relationship between the peak factor ξ, the spurious amount ACLR_{Nch} (ξ, m), and the comprehensive signal quality ratio DUR(ξ,m) as shown in FIG. 5 will be described in more detail, with reference to FIG. 6A to FIG. 6D, and eq. 1.

FIG. 6A is a graph illustrating a spectrum of a modulated signal corresponding to one channel and a spectrum of a spurious component associated therewith (where there is a spurious amount of ACLR_{1ch}). FIG. 6B is a graph illustrating the spectra of two channels of sinusoidal waves (two tones), spectra of second-order distortions associated therewith (IM2), and spectra of third-order distortions associated therewith (IM3). FIG. 6C is a graph illustrating the spectra of modulated signals corresponding to n channels and spectra of spurious components associated therewith (where there is a spurious amount of ACLR_{Nch} each). FIG. 6D is a graph illustrating the spectra of n channels of sinusoidal waves (C), as well as spectra of second-order distortions (CSO: Composite second-Order distortion) and third-order distortions (CTB: Composite Triple Beat) associated therewith. Eq. 1 is an equation representing the relationship between the spurious amount ACLR_{Nch}(ξ, m) and the comprehensive signal quality ratio DUR(ξ, m)

$$\frac{1}{DUR ( ξ , m )} = \frac{1}{CNR ( m )} + \frac{1}{- {ACLR}_{Nch} ( ξ , m )} , where \\ \begin{matrix}{ACLR}_{Nch} ( ξ , m ) = X ( m ) + κ ( ξ , m ) \\ = {[ \frac{{a}_{2}}{CSO ( m )} + \frac{{b}_{2}}{CTB ( m )} ]}^{- 1} + κ ( ξ , m ) \\ = {[ \frac{{a}_{2}}{CSO ( m )} + \frac{{b}_{2}}{CTB ( m )} ]}^{- 1} + \\ ( {ACLR}_{1 ch} ( ξ ) - {[ \frac{{a}_{1}}{IM2 ( m )} + \frac{{b}_{1}}{IM3 ( m )} ]}^{- 1} ) \\ = {[ \frac{{a}_{2}}{IM2 ( m ) + {N}_{CSO} ( m )} + \frac{{b}_{2}}{IM3 ( m ) + {N}_{CTB} ( m )} ]}^{- 1} + \\ ( {ACLR}_{1 ch} ( ξ ) - {[ \frac{{a}_{1}}{IM2 ( m )} + \frac{{b}_{1}}{IM3 ( m )} ]}^{- 1} ) .\end{matrix} \qquad eq . 1$$

By grasping the characteristics of the electrical-to-optical conversion section 107, the spurious amount ACLR_{1ch} (ξ) corresponding to one channel of the frequency division multiplexed signal for a given peak factor ξ (see FIG. 6A) can be determined. Thus, the value of the spurious amount ACLR_{1ch} (ξ) for a given peak factor ξ can be previously ascertained.

By grasping the characteristics of the electrical-to-optical conversion section 107, levels of IM2 and IM3 in the case of employing a two-tone technique can be determined (see FIG. 6B). The levels of IM2 and IM3 are values which vary depending on the optical modulation index m, and are respectively represented as IM2(m) and IM3(m) in eq. 1. Thus, IM2(m) and IM3(m) for a given optical modulation index m can be known in advance.

As shown in the proviso for eq. 1, once ACLR₁ (ξ), IM2(m), and IM3(m) are determined, a spurious factor κ (ξ, m) which varies depending on the optical modulation index m is determined. As can be seen from the proviso for eq. 1, the spurious factor κ is a parameter representing a difference between a spurious amount of a modulated signal and an amount of distortion based on sinusoidal waves. In eq. 1, a₁ and b₁ are parameters which are dependent on the modulation parameters, e.g., the band width of the modulated signal. Therefore, once the peak factor ξ is determined, then the spurious factor κ (ξ, m) is a function of m alone. Therefore, for each optical modulation index m, the value of the spurious factor κ (ξ, m) corresponding to a given peak factor ξ (hereinafter simply referred to as “spurious factor κ”) can be prescribed. For example, for a given optical modulation index m, a spurious factor κ under the peak factor ξ=ξ₁ is predetermined as κ₁, and a spurious factor κ under the peak factor ξ=ξ₂ is predetermined as κ₂. Thus, it is possible to prepare a table (hereinafter referred to as a “ξ-m-κ table”) between the peak factor ξ, the optical modulation index m, and the spurious factor κ. FIG. 7 is a schematic diagram illustrating a ξ-m-κ table. As shown in FIG. 7, the ξ-m-κ table describes, for each given peak factor ξi, a spurious factor _{κ}ik for an optical modulation index mₖ. Stated differently, the ξ-m-κ table includes m-κ lists, each defining an optical modulation index mₖ and a spurious factor κᵢₖ a for a given peak factor ξi.

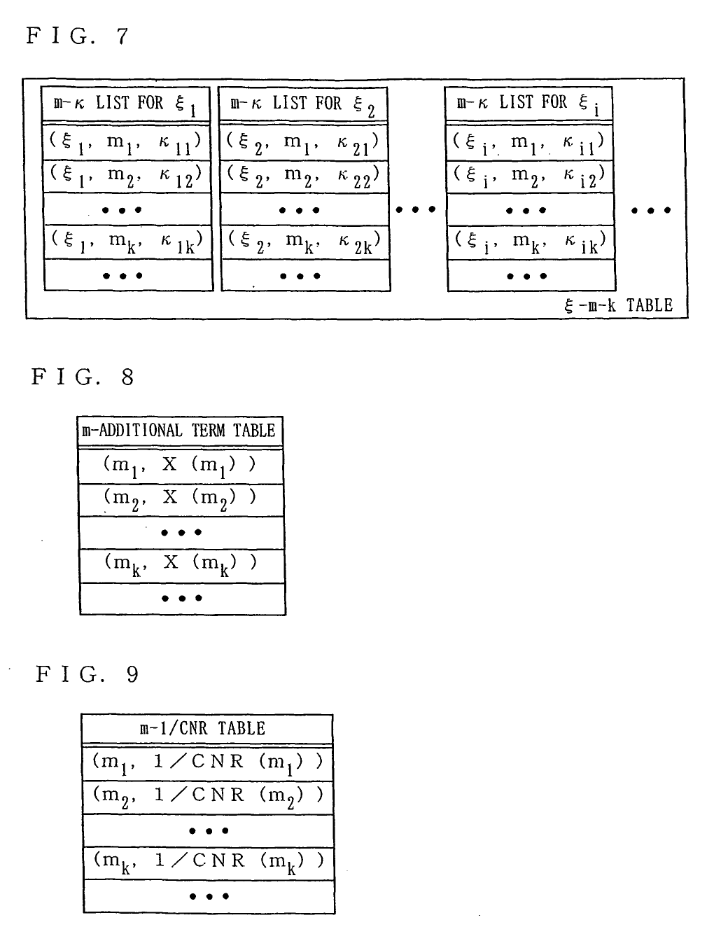

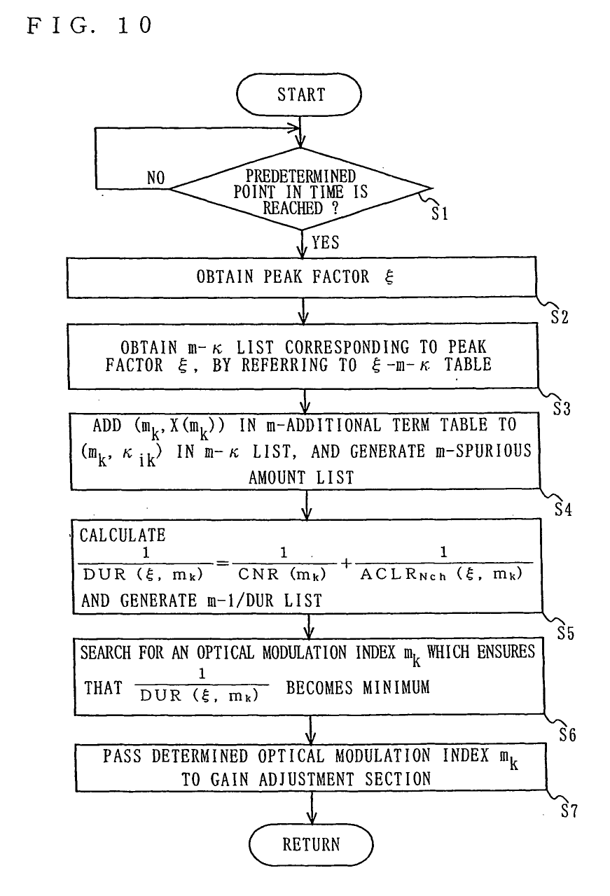

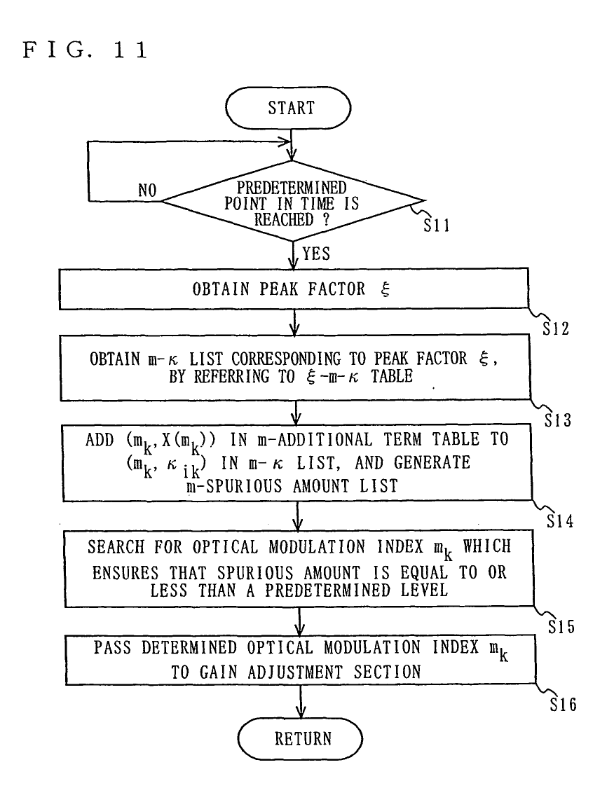

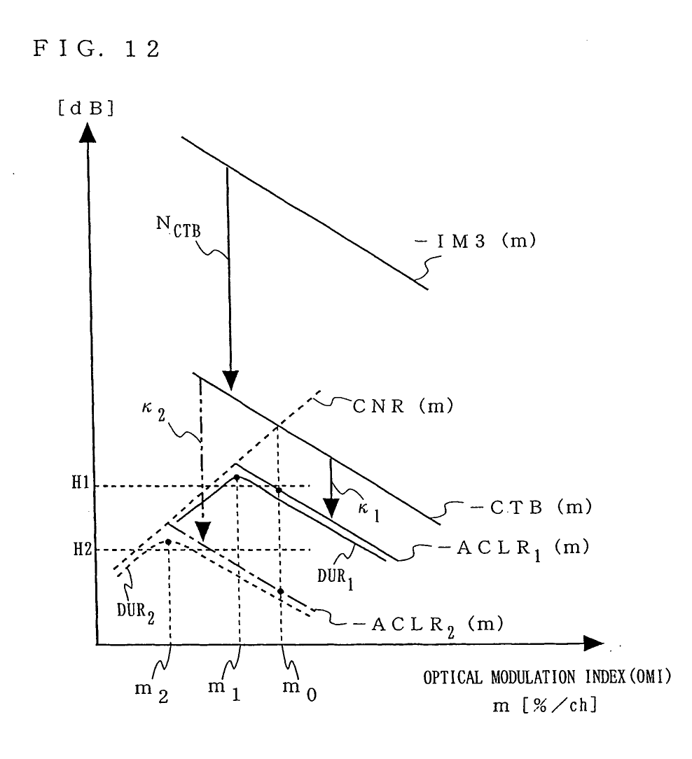

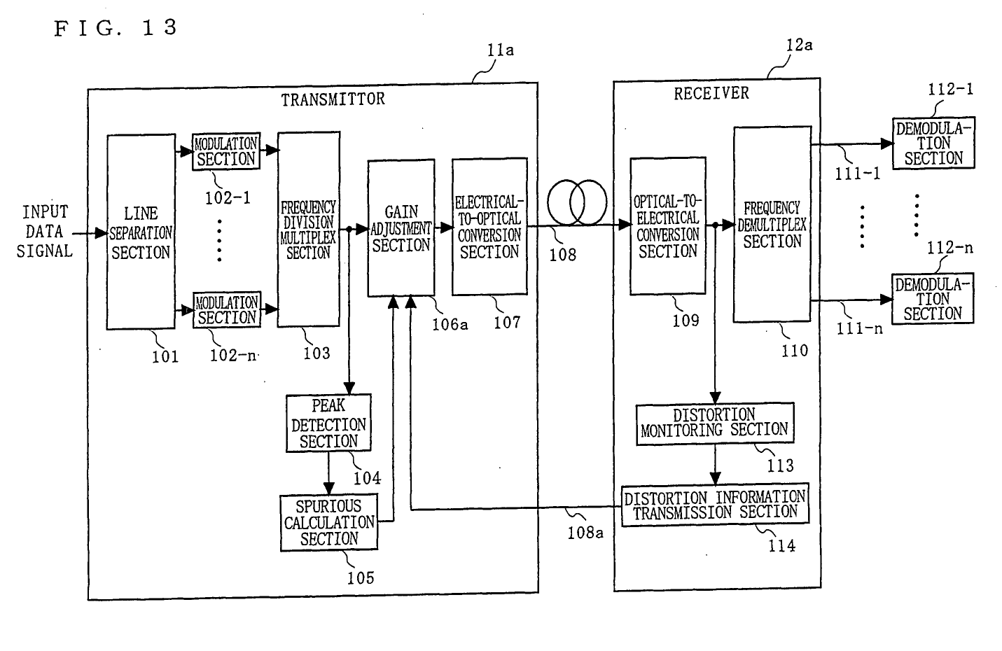

As in the case of IM2 and IM3, the levels of CSO and CTB can be determined by grasping the characteristics of the electrical-to-optical conversion section 107 (see FIG. 6D). The levels of CSO and CTB are values which vary depending on the optical modulation index m, and are respectively represented as CSO(m) and CTB(m) in eq. 1. In eq. 1, a₂ and b₂ are parameters which are dependent on the modulation parameters, e.g., the band width of the modulated signal. N_{CSO} (m) represents a ratio between CSO(m) and IM2(m). N_{CTB} (m) represents aratio between CTB(m) and IM3(m). Therefore, the value of [a₂/CSO(m)+b₂/CTB(m)]⁻¹, which is a term that is added to the spurious factor κ (hereinafter referred to as the “added term X(m)”), can be predetermined for a given optical modulation index m, in the form of a table. Such a table between the added term X(m) and the optical modulation index m will hereinafter be referred to as an m-additional term table. FIG. 8 is a schematic diagram illustrating an m-additional term table. As shown in FIG. 8, the m-additional term table describes the value of the added term X(mₖ) for each given optical modulation index mₖ.

By using the ξ-m-κ table and the m-additional term table as such, the spurious amount ACLR_{Nch} (ξ, m) for a given optical modulation index m can be determined.

CNR(m) in eq. 1 represents a carrier-to-noise ratio (Career-to-Noise Ratio) which is previously ascertained. The value of CNR(m) is dependent on the optical modulation index m. Therefore, the value of 1/CNR(m) for a given optical modulation index m can be predetermined in the form of a table. Such a table between 1/CNR(m) and the optical modulation index m will hereinafter be referred to as an m-1/CNR table. FIG. 9 is a schematic diagram illustrating an m-1/CNR table. As shown in FIG. 9, the m-1/CNR table defines 1/CNR(mₖ) for each given optical modulation index mₖ.

As described above, once the peak factor ξ is determined, the comprehensive signal quality ratio DUR(ξ,m) can be determined as a function of the optical modulation index m. Therefore, an optical modulation index m which ensures a maximum comprehensive signal quality ratio DUR(ξ, m) is an optical modulation index which can optimize the spurious component.

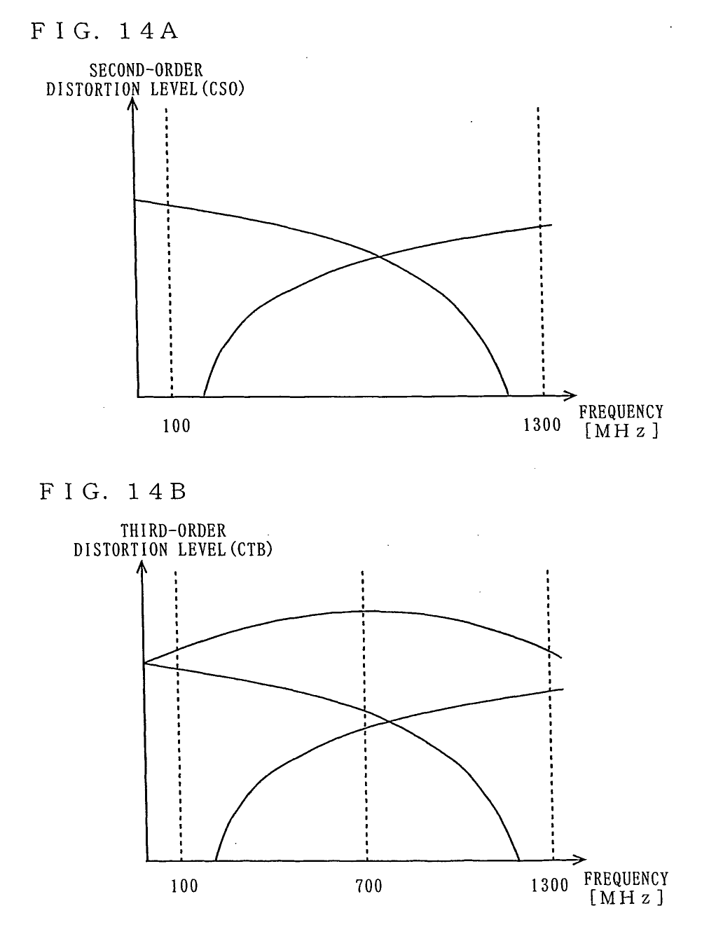

FIG. 10 is a flowchart illustrating an operation of the spurious calculation section 105. Hereinafter, with reference to FIGS. 7 to 10, the operation of the spurious calculation section 105 will be described.

First, the spurious calculation section 105 determines whether a predetermined point in time for adjusting the optical modulation index has been reached (step S1). The spurious calculation section 105 repeats this process of step S1 until reaching the predetermined point in time. The predetermined point may be a point which comes in accordance with predetermined time intervals, or may be a point which is instructed by a control section (not shown) in response to a change of the modulation parameter(s).

When the predetermined point in time is reached, the spurious calculation section 105 obtains the peak factor ξ at that moment from the peak detection section 104 (step S2).

Next, by referring to the ξ-m-κ table which is stored in a memory (not shown), the spurious calculation section 105 obtains an m-κ list which corresponds to the peak factor ξ obtained at step S2 (step S3). In the case where there is no perfectly matching ξ in the ξ-m-κ table, the spurious calculation section 105 obtains an m-κ list which corresponds to a ξ that is the closest to the detected peak factor ξ.

Next, the spurious calculation section 105 reads the m-additional term table from the memory. To the spurious factor κᵢₖ corresponding to each optical modulation index mₖ in the m-κ list table, the spurious calculation section 105 adds the value of an added term X(mₖ) corresponding to that optical modulation index mₖ from the m-additional term table, and generates a correspondence list of spurious amount ACLR_{Nch} (ξ, m) for each optical modulation index mₖ, in the form of an m-spurious amount list (step S4).

Next, the spurious calculation section 105 calculates the 1/DUR(ξ, mₖ) for each optical modulation index mₖ, by subtracting an inverse of the spurious amount ACLR_{Nch} (ξ, mₖ) in the m-spurious amount list (i.e., 1/ACLR_{Nch} (ξ, mₖ)) from each 1/CNR(mₖ) in the m-1/CNR table, and thus generates an m-1/DUR list (step S5).

Next, the spurious calculation section 105 searches the m-1/DUR list for an optical modulation index mₖ which ensures a minimum 1/DUR(ξ, mₖ) value, that is, an optical modulation index mₖ which ensures a maximum DUR(ξ, mₖ) value(step S6). The optical modulation index mₖ thus obtained is the optical modulation index which ensures a maximum comprehensive signal quality ratio value.

Next, the spurious calculation section 105 passes the optical modulation index mₖ obtained at step S6 to the gain adjustment section 106 (step S7), and returns to the process of step S1. In response, the gain adjustment section 106 determines the signal level of the frequency division multiplexed signal to be input to the electrical-to-optical conversion section 107, and outputs the frequency division multiplexed signal with its signal level being adjusted as determined.

Thus, according to the first embodiment, a peak factor of a frequency division multiplexed signal is detected, and an optical modulation index which ensures a maximum comprehensive signal quality ratio under the detected peak factor is determined. Based on this optical modulation index, the level of the frequency division multiplexed signal to be input to the electrical-to-optical conversion section is adjusted. As a result, the electrical-to-optical conversion section will operate so as to maximize the comprehensive signal quality ratio. Thus, an optical transmission system which is capable of optimizing the signal quality in accordance with the modulated signal can be provided.

The first embodiment illustrates an example where the spurious calculation section 105 relies on a ξ-m-κ table, an m-additional term table, and an m-1/CNR table to determine an optical modulation index m which ensures a maximum comprehensive signal quality ratio DUR(ξ, m) for a given peak factor ξ. Alternatively, a mathematical equation for the comprehensive signal quality ratio DUR(ξ, m) may be predefined as a function of the peak factor ξ and the optical modulation index m, and an optical modulation index m which ensures a maximum comprehensive signal quality ratio DUR(ξ, m) for a given peak factor ξ may be determined through calculations based on the mathematical equation.

The first embodiment illustrates a case of determining an optical modulation index m which ensures a maximum comprehensive signal quality ratio DUR(ξ, m) value. However, the spurious calculation section may determine an optical modulation index m which ensures that the comprehensive signal quality ratio DUR(ξ, m) is at least equal to or greater than a predetermined level.

The first embodiment illustrates a case where the spurious calculation section determines an optical modulation index m which ensures a maximum comprehensive signal quality ratio DUR(ξ,m) value on the basis of the spurious amount ACLR_{Nch}(ξ, m) and the carrier-to-noise ratio CNR(m). Alternatively, the spurious calculation section may determine an optical modulation index m which ensures that the spurious amount ACLR_{Nch}(ξ,m) is at least equal to or less than a predetermined level. Note that the spurious amount ACLR_{Nch} (ξ, m) in itself is desired-to-undesired-signal information representing a ratio between the desired signal and the undesired signal. Further alternatively, it is possible to employ −ACLR_{Nch}(ξ,m), whose sign is reversed from that of the spurious amount ACLR_{Nch}(ξ,m). Since the value of −ACLR_{Nch} (ξ, m) increases as the level of the undesired signal decreases, the spurious calculation section may determine an optical modulation index m which ensures that −ACLR_{Nch}(ξ, m), as desired-to-undesired-signal information, is equal to or greater than a predetermined level.

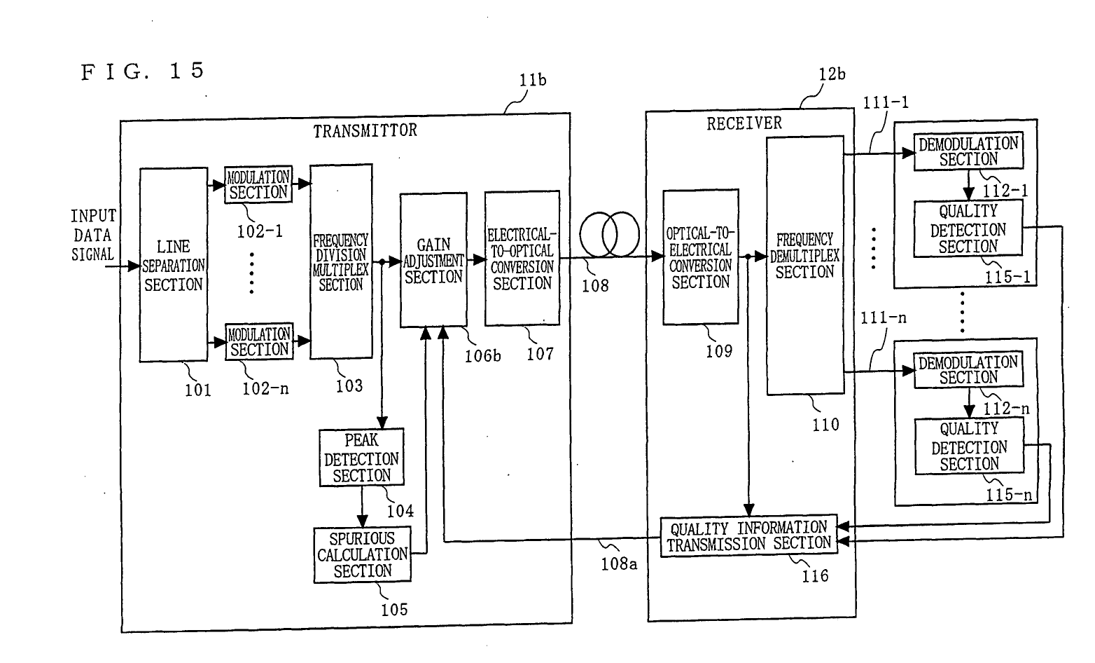

In this case, specifically, the spurious calculation section may calculate, for a peak factor ξ which has been detected by the peak detection section, an optical modulation index m which ensures that the value of the spurious amount ACLR_{Nch}(ξ,m), as expressed by eq. 1, is equal to or less than a predetermined level. Alternatively, the spurious calculation section may employ previously-stored tables to determine an optical modulation index m which ensures that the value of the spurious amount ACLR_{Nch}(ξ,m) is equal to or less than a predetermined level. FIG. 11 is a flowchart illustrating an operation of the spurious calculation section in the case of obtaining, from previously-stored tables, a value of an optical modulation index m which ensures that the value of a spurious amount ACLR_{Nch}(ξ,m) is equal to or less than a predetermined level. As shown in FIG. 11, when a predetermined point in time is reached (step S11), the spurious calculation section obtains a peak factor ξ which is detected by the peak detection section (step S12), obtains from a ξ-m-κ table an m-K list corresponding to the peak factor ξ (step S13), adds an m-additional term from an m-additional term table to the obtained M-κ list, and generates an m-spurious amount list (step S14). Then, the spurious calculation section searches the m-spurious amount list for an optical modulation index mₖ which ensures that the spurious amount is equal to or less than a predetermined level (step S15), passes the optical modulation index mₖ thus obtained to the gain adjustment section (step S16) for performing a signal level adjustment of the frequency division multiplexed signal. The predetermined level may be selected so as to define a marginally tolerable spurious amount.

In the case where the predominant cause for spurious components is the third-order distortion, the spurious calculation section 105 may determine an optimum optical modulation index by a different method from those described above. FIG. 12 is a graph illustrating, with respect to each modulated signal in a frequency division multiplexed signal which is output from the optical-to-electrical conversion section 109, dependencies on the optical modulation index of a carrier-to-noise ratio (CNR), ACLR₁ and ACLR₂ illustrated in FIG. 5, and IM3 and CTB illustrated in FIG. 6B and FIG. 6D.

Hereinafter, with reference to FIG. 12, a method for determining an optimum optical modulation index in the case where the predominant cause for spurious components is the third-order distortion will be described. In FIG. 12, the horizontal axis represents an optical modulation index m based on a reading, corresponding to a single channel, of the signal level of the frequency division multiplexed signal which is output from the frequency division multiplex section 103. The vertical axis represents values of DUR, IM3, CNR, CTB, ACLR₁, and ACLR₂ [dB] with respect to the optical modulation index. It is assumed that the carrier-to-noise ratio (CNR) due to noise has been calculated based on the characteristics of the optical devices employed in the electrical-to-optical conversion section 107, the first optical transmission path 108, and the optical-to-electrical conversion section 109, or is known through measurements. In the case where the predominant cause for spurious components is the third-order distortion, a₁=a₂=0 and b₁=b₂=1 in eq. 1. In other words, comprehensive signal quality ratio DUR has a dependency on the optical modulation index as shown in eq. 2:

$$\begin{matrix}\frac{1}{DUR ( ξ , m )} = \frac{1}{CNR ( m )} + \frac{1}{- {ACLR}_{Nch} ( ξ , m )} \\ = \frac{1}{CNR ( m )} + \frac{1}{- ( CTB ( m ) + κ ( ξ , m ) )} \\ = \frac{1}{CNR ( m )} + \frac{1}{- ( IM3 ( m ) + {N}_{CTB} ( m ) + κ ( ξ , m ) )} , where \\ κ ( ξ , m ) = {ACLR}_{1 ch} ( ξ ) - IM3 ( m ) .\end{matrix} \qquad eq . 2$$

In the case where the predominant cause for spurious components is the third-order distortion, IM3, CTB, CNR, and ACLR_{Nch}=ACLR₁ show the respective optical modulation index-dependencies as shown in FIG. 12. DUR(ξ,m), as expressed by eq. 2, exhibits a solid-line curve DUR₁ shown in FIG. 12. Therefore, the spurious calculation section 105 can determine an optimum optical modulation index (input signal level to the electrical-to-optical conversion section 107) by determining an optical modulation index m which ensures a maximum solid-line curve DUR₁ value from the graph of FIG. 12. As shown in FIG. 12, in this exemplary case, the solid-line curve DUR₁ takes a maximum value at m=m₁. Therefore, in order to obtain the optimum optical transmission quality, the gain adjustment section 106 may adjust the signal level of the frequency division multiplexed signal which is input to the electrical-to-optical conversion section 107 so that the optical modulation index equals m₁. Alternatively, an optical modulation index m which ensures that DUR(ξ,m) is equal to or greater than a predetermined level H1 may be determined.

On the other hand, in the case where ξ=ξ₂, ACLR_{Nch}=ACLR₂ is given as shown by a dot-dash line curve in FIG. 12. DUR(ξ,m) exhibits a dotted-line curve DUR₂ shown in FIG. 12. Since DUR takes a maximum value at m=m₂, the spurious calculation section 105 sets the optical modulation index to be m₂. Therefore, in order to obtain the optimum optical transmission quality, the gain adjustment section 106 may adjust the signal level of the frequency division multiplexed signal which is input to the electrical-to-optical conversion section 107 so that the optical modulation index equals m₂. Alternatively, an optical modulation index m which ensures that DUR(ξ,m) is equal to or greater than a predetermined level H2 may be determined.

Conventionally, it has been general practice to set the optical modulation index m to be m₀ on the basis of CNR and CTB. Therefore, depending on the peak factor, it has not always been possible to set the optimum optical modulation index. On the other hand, according to the present invention, the optimum optical modulation index can be dynamically changed by performing a spurious calculation in accordance with a peak factor which changes over time. Thus, the optimum optical transmission quality can be ensured.

FIG. 12 illustrates a case where the predominant cause for spurious components is the third-order distortion, i.e., where a₁=a₂=0 in eq. 1. In the case where the second-order distortion is predominant, too, a spurious component ACLR_{Nch} associated with transmission on N channels can be determined by taking a difference between a two-tone evaluation and a single channel's worth of the modulated signal.

For details of the relationship between the spurious components associated with modulated signals and distortion of sinusoidal wave signals, see, for example: Yasue et al., “Optical Access Technique for Multiple Channels of VDSL”, TECHNICAL REPORT OF IEICE, vol. 102, no. 358, OCS2002-64, pp. 17-22, Oct. 2002; and T. Yasue et al., “Scalable Optical Access System for Multi-channel VDSL based on Subcarrier Multiplexing”, OSA Tech.Digest in optical Fiber Communication Conference 2003, paper FM6, Atlanta, USA, Mar. 2003.

The first embodiment illustrates an example where the modulation method used by the first to n^{th} modulation sections 102-1 to 102-n are quadrature amplitude modulation(QAM) or discrete multitone (DMT), the modulation method is not limited thereto. For example, the modulation method may be orthogonal frequency division multiplexing (OFDM) or code division multiplexing (CDM).

The first embodiment illustrates an example where the number n of modulated signals (channels) is constant. In the case where the number n of channels is variable, the parameter N_{CSO} (m) (a ratio of the number of CSO waves to IM2) or the parameter N_{CTB} (m) (a ratio of the number of CTB waves to IM3), which are dependent on the number of channels, may be changed. Thus, the spurious calculation section 105 can easily perform a spurious calculation also in the case where the number of channels varies over time. Moreover, in the transmitter, an m-1/CNR table may be prepared for each of various numbers n of channels. In this case, when the number n of channels changes, the spurious calculation section 105 may read an m-1/CNR table that corresponds to the new number n of channels from a memory at step S5 shown in FIG. 10, and generate an m-1/DUR list corresponding to the number n of channels, thus determining the optimum optical modulation index.

The first embodiment illustrates an example where the value of the peak factor ξ is calculated by the peak detection section 104. Alternatively, the spurious calculation section 105 may calculate the value of the peak factor ξ based on an average power and a peak power which are detected by the peak detection section 104.

The first embodiment illustrates an example where the gain adjustment section 106 determines the signal level for the frequency division multiplexed signal, with respect to the optimum optical modulation index m which has been determined by the spurious calculation section 105. Alternatively, the spurious calculation section 105 may determine the signal level for the frequency division multiplexed signal based on the determined optical modulation index m, and pass the signal level thus determined to the gain adjustment section 106, which then adjusts the signal level of the frequency division multiplexed signal based on the received signal level.

### Second Embodiment

FIG. 13 is a block diagram illustrating the structure of an optical transmission system according to a second embodiment of the present invention. In FIG. 13, the optical transmission system comprises a transmitter 11a, a first optical transmission path 108, a second transmission path 108a, a receiver 12a, first to n^{th} subscriber lines 111-1 to 111-n, and first to n^{th} demodulation sections (terminal devices) 112-1 to 112-n. The transmitter 11a comprises a line separation section 101, first to n^{th} modulation sections 102-1 to 102-n, a frequency division multiplex section 103, a gain adjustment section 106a, an electrical-to-optical conversion section 107, a peak detection section 104, and a spurious calculation section 105. The receiver 12a includes an optical-to-electrical conversion section 109, a frequency demultiplex section 110, a distortion monitoring section 113, and a distortion information transmission section 114.

The receiver 12a according to the second embodiment differs from the receiver 12 according to the first embodiment in that the distortion monitoring section 113 and the distortion information transmission section 114 are additionally comprised. In FIG. 13, any portion that has a similar function to that of a counterpart in the first embodiment is denoted by the same reference numeral as used in the first embodiment, and the descriptions thereof are omitted. The second transmission path 108a may be an electrical transmission path or an optical transmission path.

The distortion monitoring section 113 detects a distortion level, at a predetermined frequency, of the frequency division multiplexed signal output from the optical-to-electrical conversion section 109. Alternatively, the distortion monitoring section 113 may detect a distortion level from the output of the frequency demultiplex section 110.

FIG. 14A is a graph illustrating exemplary frequency characteristics of second-order distortion (CSO) which is detected by the distortion monitoring section 113. FIG. 14B is a graph illustrating exemplary frequency characteristics of third-order distortion (CTB) which is detected by the distortion monitoring section 113. FIGS. 14A and 14B illustrate an example where n channels of modulated signals are deployed between 100 [MHz] and 1300[MHz] through frequency division multiplex. Although FIG. 14A appears to be showing a binary second-order distortion value for a given frequency, the illustration is to be interpreted to mean that the value of the second-order distortion increases or decreases in a certain frequency range. The same also goes for FIG. 14B.

As shown in FIG. 14A, the second-order distortion level-takes a maximum value at the lowest or highest frequency of the frequency division multiplexed signal. Therefore, the effect of the second-order distortion can be ascertained by detecting a maxim distortion value through measurements of the distortion levels in the neighborhood of the lowest frequency and in the neighborhood of the highest frequency of the frequency division multiplexed signal. In the exemplary case illustrated in FIG. 14A, for example, the maximum value of the second-order distortion (CSO) can be detected by measuring the distortion levels in the neighborhood of the lowest frequency (100[MHz]) and in the neighborhood of the highest frequency (1300[MHz]).

Moreover, as shown in FIG. 14B, the distortion level of the third-order distortion (CTB) takes a maximum value in the neighborhood of the center of the frequency band of the frequency division multiplexed signal. Therefore, the effect of the third-order distortion can be ascertained by measuring the maximum distortion value through measurements of the distortion level at the central frequency of the frequency division multiplexed signal. In the exemplary case illustrated in FIG. 14B, for example, the maximum value of the third-order distortion can be detected by measuring the distortion level in the neighborhood of the central frequency (700[MHZ]).

The distortion monitoring section 113 passes distortion level information representing the detected distortion level to the distortion information transmission section 114. The distortion information transmission section 114 sends the distortion level information to the gain adjustment section 106a via the second transmission path 108a.

Based on the distortion level information which has been transmitted over the second transmission path 108a, the gain adjustment section 106a adjusts the signal level of the frequency division multiplexed signal to be input to the electrical-to-optical conversion section 107 so that the distortion level becomes equal to or less than a predetermined distortion level. Specifically, upon receiving the distortion level information from the distortion information transmission section 114, the gain adjustment section 106a determines whether the distortion level indicated by the distortion level information is equal to or less than the predetermined distortion level. If the distortion level is equal to or less than the predetermined distortion level, the gain adjustment section 106a does not change the signal level of the frequency division multiplexed signal. On the other hand, if the distortion level is not equal to or less than the predetermined distortion level, the gain adjustment section 106a adjusts the signal level of the frequency division multiplexed signal so as to be decreased. Then, the gain adjustment section 106a again receives the distortion level information which is sent from the distortion information transmission section 114. If the distortion level indicated by the received distortion level information is not equal to or less than the predetermined distortion level, the gain adjustment section 106a further adjusts the signal level of the frequency division multiplexed signal so as to be decreased even more. In this manner, the gain adjustment section 106a keeps decreasing the signal level of the frequency division multiplexed signal until the distortion level becomes equal to or less than the predetermined distortion level.

Thus, according to the second embodiment, the gain adjustment section can adjust the signal level of the frequency division multiplexed signal by considering the influence of the distortion after an optical transmission which is performed at the receiver. As a result, the occurrence of distortion can be suppressed even better. Within a frequency band containing a plurality of modulated signals, a specific frequency band which is most susceptible to distortion is selectively monitored. Thus, the influence of the distortion can be determined without having to measure the distortion level with respect to every frequency band. Since the second embodiment is based on a similar construction to that of the first embodiment, the effects according to the first embodiment can also be obtained.

### Third Embodiment

FIG. 15 is a block diagram illustrating the structure of an optical transmission system according to a third embodiment of the present invention. In FIG. 15, the optical transmission system comprises a transmitter 11b, a first optical transmission path 108, a second transmission path 108a, a receiver 12b, first to n^{th} subscriber lines 111-1 to 111-n, first to n^{th} demodulation sections 112-1 to 112-n, and first to n^{th} quality detection sections 115-1 to 115-n. The transmitter 11b includes a line separation section 101, first to n^{th} modulation sections 102-1 to 102-n, a frequency division multiplex section 103, again adjustment section 106b, an electrical-to-optical conversion section 107, a peak detection section 104, and a spurious calculation section 105. The receiver 12b includes an optical-to-electrical conversion section 109, a frequency demultiplex section 110, and a quality information transmission section 116.

The receiver 12b according to the third embodiment differs from the receiver 12 according to the first embodiment in that the quality information transmission section 116 is additionally comprised. Another difference from the first embodiment is that the first to n^{th} quality detection sections 115-1 to 115-n are added in the subscriber terminals. In FIG. 15, any portion that has a similar function to that of a counterpart in the first or second embodiment is denoted by the same reference numeral as used in the first or second embodiment, and the descriptions thereof are omitted.

The first quality detection section 115-1, which is connected to the first demodulation section 112-1, monitors the signal quality of the first modulated signal which is transmitted from the first subscriber line 111-1. Specifically, the first quality detection section 115-1 detects a SNR (signal to noise ratio) or bit error rate as signal quality information. The first quality detection section 115-1 transmits the signal quality information indicating the detected signal quality to the quality information transmission section 116. The transmission of the signal quality information may utilize the subscriber line, or any other line. The operation of the second to n^{th} quality detection sections 115-2 to 115-n is the same as that of the first quality detection section 115-1.

Via the second transmission path 108a, which is installed for enabling bidirectional communications, the quality information transmission section 116 transmits the signal quality information of the first to n^{th} modulated signals to the gain adjustment section 106b.

Based on the signal quality information which is transmitted over the second transmission path 108a, the gain adjustment section 106b adjusts the signal level of the frequency division multiplexed signal to be input to the electrical-to-optical conversion section 107 so that the signal quality of the modulated signal satisfies a predetermined quality level. Specifically, upon receiving the signal quality information from the quality information transmission section 116, the gain adjustment section 106b determines whether the signal quality indicated by the signal quality information satisfies the predetermined quality level. If the signal quality satisfies the predetermined quality level, the gain adjustment section 106b does not change the signal level of the frequency division multiplexed signal. On the other hand, if the signal quality does not satisfy the predetermined quality level, the gain adjustment section 106b adjusts the signal level of the frequency division multiplexed signal so as to be decreased. Then, the gain adjustment section 106b again receives the signal quality information transmitted from the quality information transmission section 116. If the signal quality indicated by the received signal quality information does not satisfy the predetermined quality level, the gain adjustment section 106b further adjusts the signal level of the frequency division multiplexed signal so as to be decreased even more. Thus, the gain adjustment section 106b keeps decreasing the signal level of the frequency division multiplexed signal until the signal quality satisfies the predetermined quality level. Alternatively, the adjustment section 106b may keep adjusting the signal level so as to be increased.

Thus, according to the third embodiment, the gain adjustment section adjusts the signal level of the frequency division multiplexed signal based on the signal quality of a modulated signal, whereby the signal quality of the modulated signal can be maintained above a predetermined quality level. The monitoring of the signal quality can be easily performed by utilizing a standard function of a VDSL modem composing the demodulation section. Since the second embodiment is based on a similar construction to that of the first embodiment, the effects according to the first embodiment can also be obtained.

### Variant of the Embodiments

The first to third embodiments have illustrated examples where peak information detection is performed based on a frequency division multiplexed signal which is output from the frequency division multiplex section 103. However, the present invention is not limited thereto.

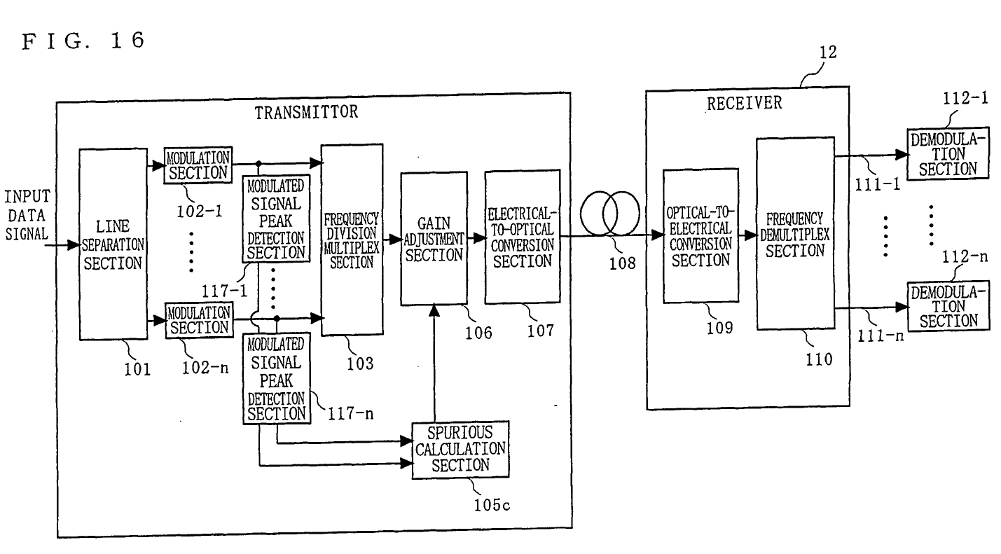

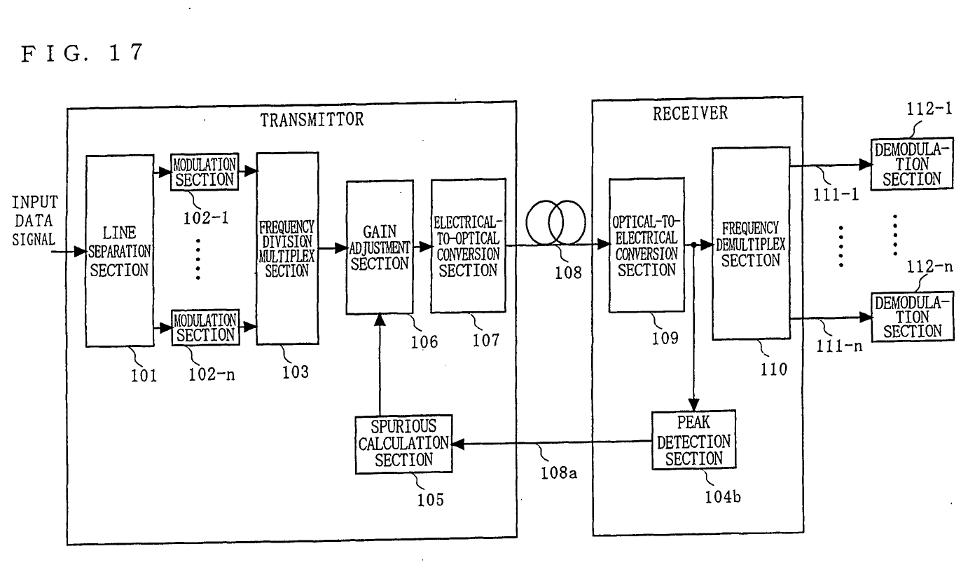

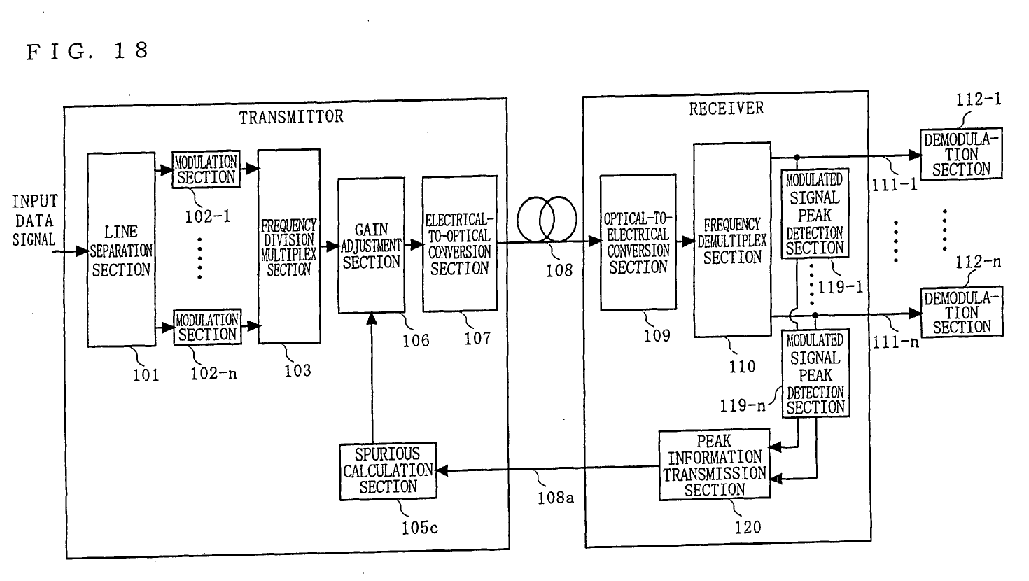

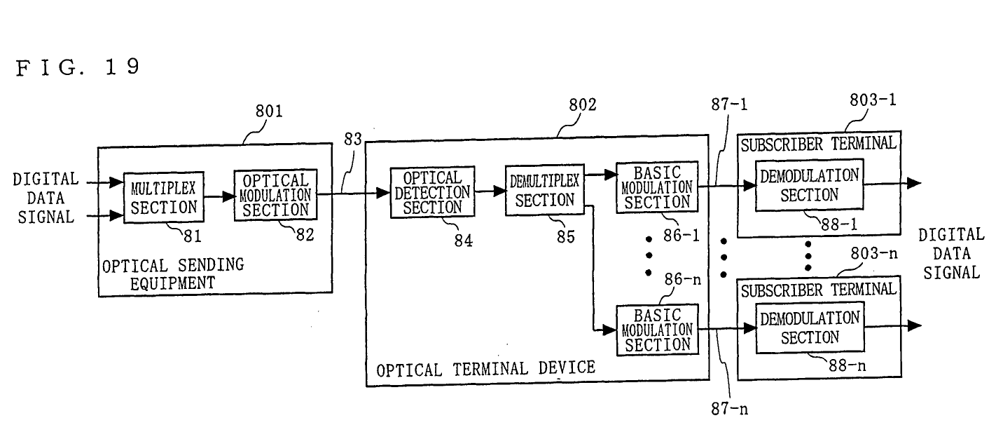

FIG. 16 is a block diagram illustrating the structure of an optical transmission system in the case where peak information is obtained by detecting peak values of first to n^{th} modulated signals which are output from the first to n^{th} modulation sections 102-1 to 102-n. In FIG. 16, any portion that has a similar function to that of a counterpart in the first embodiment is denoted by the same reference numeral as used in the first embodiment. In FIG. 16, the first to n^{th} modulated signal peak detection sections 117-1 to 117-n detect peak voltages and average voltages of the first to n^{th} modulated signals, respectively, and send the detected peak voltages and average voltages to the spurious calculation section 105c. The first to n^{th} modulated signal peak detection sections 117-1 to 117-n together compose one peak detection section. The spurious calculation section 105c calculates an arithmetic mean value of the peak voltages and an arithmetic mean value of the average voltages of the first to n^{th} modulated signals which have been sent from the first to n^{th} modulated signal peak detection sections 117-1 to 117-n. By using the calculated mean values as the peak voltage and average voltage of the frequency division multiplexed signal, the spurious calculation section 105c determines a peak factor ξ of the frequency division multiplexed signal. Thereafter, in a manner similar to the first embodiment, the spurious calculation section 105c determines an optimum optical modulation index m based on the calculated peak factor ξ, and sends the optical modulation index m to the gain adjustment section 106.

Thus, similar effects to those according to the first embodiment can be provided. Since a peak factor is obtained based on the peak value of each modulated signal, a more accurate peak factor can be obtained in the case where the modulation sections employ different modulation parameters, for example. As in the case of the second embodiment, the optical transmission system shown in FIG. 16 may be provided with a means for monitoring distortion levels. As in the case of the third embodiment, the optical transmission system shown in FIG. 16 may be provided with a means for monitoring the signal quality.

FIG. 17 is a block diagram illustrating the structure of an optical transmission system in the case where peak information is obtained by detecting peak values of a frequency division multiplexed signal which is output from the optical-to-electrical conversion section 109. In FIG. 17, any portion that has a similar function to that of a counterpart in the first or second embodiment is denoted by the same reference numeral as used in the first or second embodiment. In FIG. 17, in a manner similar to the peak detection section 104 according to the first embodiment, the peak detection section 104b determines a peak factor ξ from a frequency division multiplexed signal which is output from the optical-to-electrical conversion section 109, and transmits the peak factor ξ to the spurious calculation section 105 via the second transmission path 108a. In a manner similar to the first embodiment, the spurious calculation section 105 determines an optimum optical modulation index m based on the peak factor ξ which has been sent from the peak detection section 104b, and sends the optical modulation index m to the gain adjustment section 106.

Thus, similar effects to those according to the first embodiment can be provided. Note that the spurious calculation section 105 may alternatively be provided at the receiver 12, in which case the gain adjustment section 106 adjusts the level of the frequency division multiplexed signal based on the optical modulation index which is fed back to the transmitter 11. As in the case of the second embodiment, the optical transmission system shown in FIG. 17 may be provided with a means for monitoring distortion levels. As in the case of the third embodiment, the optical transmission system shown in FIG. 17 may be provided with a means for monitoring the signal quality.

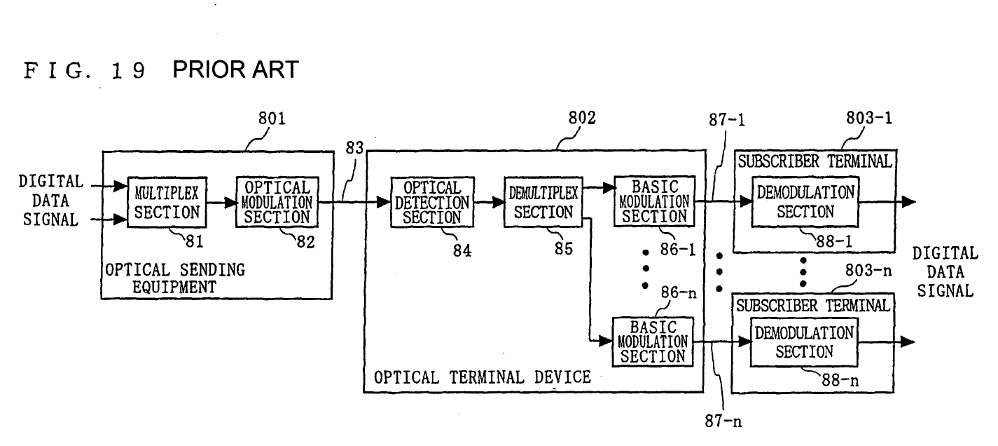

FIG. 18 is a block diagram illustrating the structure of an optical transmission system in the case where peak information is obtained by detecting peak values of first to n^{th} modulated signals which are output from the frequency demultiplex section 110. In FIG. 18, any portion that has a similar function to that of a counterpart in the first embodiment is denoted by the same reference numeral as used in the first embodiment. In FIG. 18, the first to n^{th} modulated signal peak detection sections 119-1 to 119-n detect peak voltages and average voltages of the first to n^{th} modulated signals, respectively, and send the detected peak voltages and average voltages to the peak information transmission section 120. The peak information transmission section 120 send the peak voltages and average voltages of the first to n^{th} modulated signals, which have been sent from the first to n^{th} modulated signal peak detection sections 119-1 to 119-n, to the spurious calculation section 105c via the second transmission path 108a. The first to n^{th} modulated signal peak detection sections 119-1 to 119-n and the peak information transmission section 120 together compose one peak detection section. The spurious calculation section 105c calculates an arithmetic mean value of the peak voltages and an arithmetic mean value of the average voltages of the first to n^{th} modulated signals which have been sent from the first to n^{th} modulated signal peak detection sections 119-1 to 119-n. By using the calculated mean values as the peak voltage and average voltage of the frequency division multiplexed signal, the spurious calculation section 105c determines a peak factor ξ of the frequency division multiplexed signal. Thereafter, in a manner similar to the first embodiment, the spurious calculation section 105c determines an optimum optical modulation index m based on the calculated peak factor ξ, and sends the optical modulation index m to the gain adjustment section 106.

Thus, similar effects to those according to the first embodiment can be provided. Since a peak factor is obtained based on the peak value of each modulated signal, a more accurate peak factor can be obtained in the case where the modulation sections employ different modulation parameters, for example. Note that the spurious calculation section 105c may alternatively be provided at the receiver 12, in which case the gain adjustment section 106 adjusts the level of the frequency division multiplexed signal based on the optical modulation index which is fed back to the transmitter 11. As in the case of the second embodiment, the optical transmission system shown in FIG. 18 may be provided with a means for monitoring distortion levels. As in the case of the third embodiment, the optical transmission system shown in FIG. 18 may be provided with a means for monitoring the signal quality.

Although the above embodiments illustrate examples where the transmitter and the receiver are on a one-to-one relationship, a single transmitter may be used in conjunction with a plurality of receivers. In the case where a single transmitter is used in conjunction with a plurality of receivers and where information is to be fed back from the receivers to the transmitter as shown in FIGS. 13, 15, 17, and 18, information may be fed back from each receiver, and the transmitter may adjust the level of the frequency division multiplexed signal based on the respective fed back information.

### INDUSTRIAL APPLICABILITY

An optical transmission system, and a transmitter, a receiver, and a signal level adjustment method for use therein according to the present invention can reduce spurious components occurring in the neighborhood of the spectra of modulated signals, and therefore are useful in the field of optical communications and the like.

1. An optical transmission system having: a transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex; a receiver for converting the optical signal having been transmitted over the optical transmission path back into the frequency division multiplexed signal, and separating the frequency division multiplexed signal into the first to n^{th} modulated signals; and first to n^{th} terminal devices which are connected to the receiver via the first to n^{th} connection lines, respectively, for receiving the separated modulated signals, the system comprising:
a peak detection section for detecting peak information concerning a peak of a signal level of the frequency division multiplexed signal;
a spurious calculation section for, based on the peak information detected by the peak detection section, calculating desired-to-undesired-signal information of the frequency division multiplexed signal, and determining signal level information concerning a signal level for the frequency division multiplexed signal which ensures that the desired-to-undesired-signal information is equal to or greater than a predetermined level; and
a gain adjustment section provided in the transmitter for, based on the signal level information determined by the spurious calculation section, adjusting the signal level of the frequency division multiplexed signal when being converted to the optical signal.

2. The optical transmission system according to claim 1, wherein the transmitter includes:
first to n^{th} modulation sections for generating the first to n^{th} modulated signals based on first to n^{th} data signals to be transmitted to the first to n^{th} terminal devices;
a frequency division multiplex section for outputting the frequency division multiplexed signal by subjecting the first to n^{th} modulated signals which are output from the first to n^{th} modulation sections to a frequency division multiplex; and
an electrical-to-optical conversion section for converting into the optical signal the frequency division multiplexed signal which is output from the frequency division multiplex section, the signal level of the frequency division multiplexed signal having been adjusted by the gain adjustment section, and for sending the optical signal onto the optical transmission path, and
the receiver includes:
an optical-to-electrical conversion section for receiving the optical signal having been transmitted via the optical transmission path, and converting the optical signal back into the frequency division multiplexed signal; and
a frequency demultiplex section for extracting the first to n^{th} modulated signals from the frequency division multiplexed signal which is output from the optical-to-electrical conversion section, and sending the first to n^{th} modulated signals onto the first to n^{th} connection lines, respectively, and
the first to n^{th} terminal devices each include a demodulation section for demodulating the modulated signal which is transmitted over a corresponding one of the first to n^{th} connection lines.

3. The optical transmission system according to claim 2, wherein,
the desired-to-undesired-signal information is spurious information concerning a spurious component of the frequency division multiplexed signal occurring in the electrical-to-optical conversion section and the frequency division multiplexed signal itself, and
the spurious calculation section determines, as the signal level information, information concerning a signal level for the frequency division multiplexed signal which ensures that a level of the spurious component represented by the spurious information is equal to or less than a predetermined level.

4. The optical transmission system according to claim 3, wherein,
the peak information is expressed by a peak factor ξ, which represents a ratio of a peak power to an average power of the frequency division multiplexed signal,
the spurious information is expressed by an adjacent channel leakage power ratio, which is determined in terms of:
a spurious factor κ which is determined based on: a spurious amount, in accordance with the peak factor ξ, of a modulated signal corresponding to one channel; a level of second-order distortion which is in accordance with a given optical modulation index m in the electrical-to-optical conversion section; and a level of third-order distortion which is in accordance with the given optical modulation index m in the electrical-to-optical conversion section;
a level of composite second-order distortion of the frequency division multiplexed signal which is in accordance with the given optical modulation index m in the electrical-to-optical conversion section; and
a level of composite third-order distortion of the frequency division multiplexed signal which is in accordance with the given optical modulation index m in the electrical-to-optical conversion section, and
the spurious calculation section determines, as the signal level information, an optical modulation index m which ensures that the adjacent channel leakage power ratio is equal to or less than a predetermined level.

5. The optical transmission system according to claim 4, further comprising a ξ-m-κ table storage section for previously storing a ξ-m-κ table indicating correspondence between the peak factor ξ, the optical modulation index m in the electrical-to-optical conversion section, and the spurious factor κ,
wherein the spurious calculation section is operable to:
determine a spurious factor κ which corresponds to the peak factor ξ detected by the peak detection section, by referring to the ξ-m-κ table stored in the ξ-m-κ table storage section; and
search for an optical modulation index m which ensures that the adjacent channel leakage power ratio, which is expressed by the spurious factor κ, the level of composite second-order distortion, and the level of composite third-order distortion, is equal to or less than a predetermined level, and determines the optical modulation index m thus found as the signal level information.

6. The optical transmission system according to claim 2, wherein the desired-to-undesired-signal information is a comprehensive signal quality ratio which is defined based on: spurious information concerning a spurious component of the frequency division multiplexed signal occurring in the electrical-to-optical conversion section; and carrier-to-noise information, and
the spurious calculation section determines, as the signal level information, information concerning a signal level for the frequency division multiplexed signal which ensures that the comprehensive signal quality ratio becomes maximum.

7. The optical transmission system according to claim 6, wherein,
the peak information is expressed by a peak factor ξ, which represents a ratio of a peak power to an average power of the frequency division multiplexed signal,
the spurious information is expressed by an adjacent channel leakage power ratio, which is determined in terms of:
a spurious factor κ which is determined based on: a spurious amount, in accordance with the peak factor ξ, of a modulated signal corresponding to one channel; a level of second-order distortion which is in accordance with a given optical modulation index m in the electrical-to-optical conversion section; and a level of third-order distortion which is in accordance with the given optical modulation index m in the electrical-to-optical conversion section;
a level of composite second-order distortion of the frequency division multiplexed signal which is in accordance with the given optical modulation index m in the electrical-to-optical conversion section; and
a level of composite third-order distortion of the frequency division multiplexed signal which is in accordance with the given optical modulation index m in the electrical-to-optical conversion section,
the carrier-to-noise information is expressed as a function of the optical modulation index m in the electrical-to-optical conversion section,
the optical transmission system further comprises:
a ξ-m-κ table storage section for previously storing a ξ-m-κ table indicating correspondence between the peak factor ξ, the optical modulation index m in the electrical-to-optical conversion section, and the spurious factor κ; and
a carrier-to-noise information storage section for previously storing correspondence between the optical modulation index m in the electrical-to-optical conversion section and the carrier-to-noise information,
the spurious calculation section is operable to:
determine a spurious factor κ which corresponds to the peak factor ξ detected by the peak detection section, by referring to the ξ-m-κ table stored in the ξ-m-κ table storage section;
determine the adjacent channel leakage power ratio which is expressed by the spurious factor κ, the level of composite second-order distortion, and the level of composite third-order distortion; and
determine, as the signal level information, an optical modulation index m in the electrical-to-optical conversion section which ensures that the comprehensive signal quality ratio, which is expressed by the adjacent channel leakage power ratio and the carrier-to-noise information, becomes maximum.

8. The optical transmission system according to claim 2, wherein the peak detection section detects the peak information by detecting the signal level of the frequency division multiplexed signal which is output from the frequency division multiplex section.

9. The optical transmission system according to claim 2, wherein the peak detection section detects the peak information based on information concerning peaks of the first to n^{th} modulated signals which are output from the first to n^{th} modulation sections.

10. The optical transmission system according to claim 2, wherein the peak detection section detects the peak information by detecting the signal level of the frequency division multiplexed signal which is output from the optical-to-electrical conversion section.

11. The optical transmission system according to claim 2, wherein the peak detection section detects the peak information by detecting the signal levels of the first to n^{th} modulated signals which are output from the frequency demultiplex section.

12. The optical transmission system according to claim 2, wherein,
the frequency division multiplex section includes a frequency conversion section for converting the first to n^{th} modulated signals to signals having respectively different frequencies, and
the frequency demultiplex section includes an inverse frequency conversion section for converting the first to n^{th} modulated signals contained in the frequency division multiplexed signal to signals having their respective original frequencies.

13. The optical transmission system according to claim 2, wherein the spurious calculation section determines the desired-to-undesired-signal information in accordance with a number n of channels of modulated signals.

14. The optical transmission system according to claim 2, wherein the receiver further includes:
a distortion monitoring section for detecting a distortion level, at a predetermined frequency, of the frequency division multiplexed signal which is output from the electrical-to-optical conversion section; and
a distortion information transmission section for transmitting distortion level information to the transmitter, the distortion level information representing the distortion level which is detected by the distortion monitoring section, and
based on the distortion level information which is transmitted from the distortion information transmission section, the gain adjustment section adjusts the signal level of the frequency division multiplexed signal which is input to the electrical-to-optical conversion section so that the distortion level which is detected by the distortion monitoring section is equal to or less than a predetermined level.

15. The optical transmission system according to claim 2, wherein,
each terminal device further includes a quality detection section for detecting a signal quality of an output signal from the demodulated by the demodulation section, and transmitting the signal quality as signal quality information to the transmitter via the receiver, and
the gain adjustment section adjusts the signal level of the frequency division multiplexed signal which is input to the electrical-to-optical conversion section so that the signal quality which is represented by the incoming signal quality information satisfies a predetermined quality level.

16. A transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex, the transmitter comprising:
a peak detection section for detecting peak information concerning a peak of a signal level of the frequency division multiplexed signal;
a spurious calculation section for, based on the peak information detected by the peak detection section, calculating desired-to-undesired-signal information of the frequency division multiplexed signal, and determining signal level information concerning a signal level for the frequency division multiplexed signal which ensures that the desired-to-undesired-signal information is equal to or greater than a predetermined level; and
a gain adjustment section for, based on the signal level information determined by the spurious calculation section, adjusting the signal level of the frequency division multiplexed signal when being converted to the optical signal.

17. A receiver for use in conjunction with a transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex, the receiver converting the optical signal having been transmitted from the transmitter back into the frequency division multiplexed signal and separating the frequency division multiplexed signal into the first to n^{th} modulated signals, the receiver comprising:
a peak detection section for detecting peak information concerning a peak of a signal level of the frequency division multiplexed signal,
wherein,
the peak information detected by the peak detection section is used for calculating desired-to-undesired-signal information of the frequency division multiplexed signal, the desired-to-undesired-signal information being used for determining signal level information concerning a signal level for the frequency division multiplexed signal which ensures that the desired-to-undesired-signal information is equal to or greater than a predetermined level; and
the signal level information is used for adjusting the signal level of the frequency division multiplexed signal when being converted to the optical signal.

18. A signal level adjustment method for adjusting a signal level of a frequency division multiplexed signal for use in an optical transmission system having: a transmitter for converting a frequency division multiplexed signal to an optical signal and sending the optical signal onto an optical transmission path, the frequency division multiplexed signal being composed of first to n^{th} modulated signals (where n is an integer which is equal to or greater than two) having been subjected to a frequency division multiplex; a receiver for converting the optical signal having been transmitted over the optical transmission path back into the frequency division multiplexed signal, and separating the frequency division multiplexed signal into the first to n^{th} modulated signals; and first to n^{th} terminal devices which are connected to the receiver via the first to n^{th} connection lines, respectively, for receiving the separated modulated signals, the method comprising the steps of:
detecting peak information concerning a peak of a signal level of the frequency division multiplexed signal;
calculating desired-to-undesired-signal information of the frequency division multiplexed signal based on the detected peak information;
determining signal level information concerning a signal level for the frequency division multiplexed signal which ensures that the desired-to-undesired-signal information is equal to or greater than a predetermined level; and
based on the signal level information, adjusting the signal level of the frequency division multiplexed signal when being converted to the optical signal.
